(19) United States
(12) Patent Application Publication
(10) Pub. No.: US 2026/0278858 A1
(43) Pub. Date: Sep. 17, 2026

(54) DATA PROCESSING METHOD, APPARATUS, DEVICE, MEDIUM, AND PRODUCT

(71) Applicants: Beijing Zitiao Network Technology Co., Ltd., Beijing (CN); Beijing Youzhuju Network Technology Co., Ltd., Beijing (CN)

(72) Inventors: Huichao ZHANG, Beijing (CN); Li'ao QU, Beijing (CN); Yiheng LIU, Beijing (CN); Xu WANG, Beijing (CN); Yi JIANG, Beijing (CN); Hu YE, Beijing (CN); Yiming GAO, Beijing (CN); Kang DU, Beijing (CN); Xinglong WU, Beijing (CN)

(21) Appl. No.: 19/566,846

(22) Filed: Mar. 13, 2026

(30) Foreign Application Priority Data
Mar. 14, 2025 (CN) 202510308427.6

(51) Int. Cl. G06T 11/00

(52) U.S. Cl. CPC G06T 11/00

(57) ABSTRACT

Provided are a data processing method and apparatus, a device, a medium and a product. The method includes: first, obtaining at least one piece of data; then, for any piece of data of the at least one piece of data, obtaining, from a dictionary of a target model, a discrete feature matching an index determination result of the piece of data, such that the discrete feature may represent information carried by the piece of data; and then, performing, by using the target model, prediction processing on the discrete feature, to obtain an index prediction result, such that the index prediction result is used to indicate a usage probability of each index in an index sequence of the dictionary, and an index with a largest usage probability indicated by the index prediction result is an index corresponding to a certain text or an index corresponding to a certain image.

### CROSS-REFERENCE TO RELATED APPLICATIONS

This application claims priority to Chinese Patent Application No. 202510308427.6, entitled “DATA PROCESSING METHOD, APPARATUS, DEVICE, MEDIUM, AND PRODUCT”, and filed on Mar. 14, 2025. The entire disclosure of the prior application is hereby incorporated by reference in its entirety.

### TECHNICAL FIELD

The present application relates to the field of data processing technologies, and in particular, to a data processing method and apparatus, a device, a medium, and a product.

### BACKGROUND

Image understanding (such as multimodal understanding) is a technology for generating a text based on a text and an image, so that the technology may be used to implement a plurality of tasks, such as a question answering task for an image, a text recognition task for an image, or a target detection task for an image. For ease of understanding, description is provided below with reference to an example.

As an example, when a user provides an image and a text “What is next to the chair in the image”, a machine learning model with an image understanding function, such as a vision language model (Vision Language Model, VLM) may be used to process the image and the text, to obtain and output a text “a trash can and a bucket of water”, to satisfy a requirement for image question answering in the current scenario.

Image generation (such as text-to-image generation) is a technology for generating an image based on a text, so that the technology may be used to implement a plurality of tasks, such as a novel-to-video task and an automatic painting task. For ease of understanding, description is provided below with reference to an example.

As an example, when a user provides a text “A puppy is playing happily on the beach”, a machine learning model with an image generation function, such as a diffusion model, may be used to process the text, to obtain and output an image, to satisfy a requirement for image generation in the current scenario.

### SUMMARY

To solve the above technical problem, the present application provides a data processing method and apparatus, a device, a medium, and a product.

To achieve the above objective, the present application provides the following technical solutions:

The present application provides a data processing method. The method includes: obtaining at least one piece of data, where the at least one piece of data includes a text and/or an image; for any piece of data of the at least one piece of data, obtaining, from a dictionary of a target model, a discrete feature matching an index determination result of the piece of data, where in response to the piece of data being a text, the index determination result is determined according to a text codebook, and in response to the piece of data being an image, the index determination result is determined according to an image codebook, where the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and performing, by using the target model, prediction processing on the discrete feature matching the index determination result, to obtain an index prediction result, where the index prediction result is used to indicate a usage probability of each index in the index sequence, and a discrete feature indicated by an index with a largest usage probability that is indicated by the index prediction result in the dictionary is used to generate prediction data corresponding to the at least one piece of data.

In a possible implementation, the index sequence includes a first index set and a second index set, where an arrangement position of each index in the first index set precedes that of each index in the second index set in the index sequence; the first index set includes indices in a codebook corresponding to the first index set, the second index set is obtained by separately adding a preset offset to indices in a codebook corresponding to the second index set, and the preset offset is used to indicate a number of indices in the codebook corresponding to the first index set; and the codebook corresponding to the first index set is the text codebook, and the codebook corresponding to the second index set is the image codebook; or the codebook corresponding to the first index set is the image codebook, and the codebook corresponding to the second index set is the text codebook.

In a possible implementation, in response to the index with the largest usage probability belonging to the first index set, the discrete feature indicated by the index with the largest usage probability in the dictionary is obtained by searching the codebook corresponding to the first index set for a discrete feature indicated by the index with the largest usage probability; or in response to the index with the largest usage probability belonging to the second index set, the discrete feature indicated by the index with the largest usage probability in the dictionary is obtained by searching the codebook corresponding to the second index set for a discrete feature indicated by a difference between the index with the largest usage probability and the preset offset.

In a possible implementation, the obtaining, from a dictionary of a target model, a discrete feature matching an index determination result of the piece of data includes: in response to the piece of data being a text, searching the text codebook for a discrete feature indicated by the index determination result of the piece of data, as the discrete feature matching the index determination result of the piece of data; or in response to the piece of data being an image, searching the image codebook for a discrete feature indicated by the index determination result of the piece of data, as the discrete feature matching the index determination result of the piece of data.

In a possible implementation, the discrete feature indicated by each index in the text codebook belongs to a text feature space; and a mapping layer in the target model is configured to map a discrete feature searched for from the image codebook to the text feature space, and both output data of the mapping layer and the discrete feature searched for from the text codebook participate in the prediction processing.

In a possible implementation, the method further includes: obtaining at least one index and a discrete feature indicated by each index of the at least one index, where each index of the at least one index is different from each index in the text codebook, discrete features indicated by different indices of the at least one index are used to describe different images, and the discrete feature indicated by each index of the at least one index and the discrete feature indicated by each index in the text codebook belong to a same feature space; expanding the text codebook to obtain the dictionary, by using the at least one index and the discrete feature indicated by each index of the at least one index; and updating the dictionary according to the index prediction result and an index determination result of label data corresponding to the at least one piece of data, and then continuing to perform the step of obtaining the at least one piece of data, where the label data is used to indicate a ground-truth of the prediction data, in response to the label data being a text, the index determination result of the label data is determined according to the text codebook, and in response to the label data being an image, the index determination result of the label data is determined according to the image codebook.

In a possible implementation, the obtaining at least one index and a discrete feature indicated by each index of the at least one index includes: obtaining the at least one index, and randomly generating the discrete feature indicated by each index of the at least one index; or separately adding each index in the image codebook to a number of indices in the text codebook to obtain the at least one index, and separately mapping the discrete feature indicated by each index in the image codebook to the same feature space to obtain the discrete feature indicated by each index of the at least one index.

In a possible implementation, the obtaining, from a dictionary of a target model, a discrete feature matching an index determination result of the piece of data includes: in response to the piece of data being a text, searching the dictionary for a discrete feature indicated by the index determination result of the piece of data, as the discrete feature matching the index determination result of the piece of data; or in response to the piece of data being an image, adjusting the index determination result of the piece of data to obtain an adjusted index, where the at least one index includes the adjusted index, and searching the dictionary for a discrete feature indicated by the adjusted index, as the discrete feature matching the index determination result of the piece of data.

In a possible implementation, the method further includes: in response to the label data being an image, adjusting the index determination result of the label data to obtain an adjustment result, where the at least one index includes the adjustment result; and the updating the dictionary according to the index prediction result and an index determination result of label data corresponding to the at least one piece of data includes: updating the dictionary according to the index prediction result and the adjustment result.

In a possible implementation, the discrete feature indicated by each index in the image codebook includes a semantic-level discrete feature and a pixel-level discrete feature; and/or the target model includes one prediction head, and the index prediction result is output by the prediction head.

The present application provides a data processing apparatus, including: a first obtaining unit configured to obtain at least one piece of data, where the at least one piece of data includes a text and/or an image; a second obtaining unit configured to: for any piece of data of the at least one piece of data, obtain, from a dictionary of a target model, a discrete feature matching an index determination result of the piece of data, where in response to the piece of data being a text, the index determination result is determined according to a text codebook, and in response to the piece of data being an image, the index determination result is determined according to an image codebook, where the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and a prediction processing unit configured to perform, by using the target model, prediction processing on the discrete feature matching the index determination result, to obtain an index prediction result, where the index prediction result is used to indicate a usage probability of each index in the index sequence, and a discrete feature indicated by an index with a largest usage probability that is indicated by the index prediction result in the dictionary is used to generate prediction data corresponding to the at least one piece of data.

The present application provides an electronic device. The device includes a processor and a memory. The memory is configured to store an instruction or a computer program. The processor is configured to execute the instruction or the computer program in the memory, to enable the electronic device to perform the data processing method provided in the present application.

The present application provides a computer-readable medium having an instruction or a computer program stored thereon. When the instruction or the computer program is run on a device, the device is enabled to perform the data processing method provided in the present application.

The present application provides a computer program product including a computer program carried on a non-transitory computer-readable medium, where the computer program includes program code for performing the data processing method provided in the present application.

### BRIEF DESCRIPTION OF THE DRAWINGS

To describe the technical solutions in the embodiments of the present application or in the related art more clearly, the following briefly describes drawings required for describing the embodiments or the related art. Apparently, the drawings in the following description show merely some embodiments of the present application, and a person of ordinary skill in the art may still derive other drawings from these drawings without creative efforts.

FIG. 1 is a schematic diagram of an image understanding process according to an embodiment of the present application;

FIG. 2 is a schematic diagram of an image generation process according to an embodiment of the present application;

FIG. 3 is a flowchart of a data processing method according to an embodiment of the present application;

FIG. 4 is a schematic structural diagram of a target model according to an embodiment of the present application;

FIG. 5 is a schematic structural diagram of another target model according to an embodiment of the present application;

FIG. 6 is a schematic diagram of three-stage training according to an embodiment of the present application;

FIG. 7 is a schematic diagram of another three-stage training according to an embodiment of the present application;

FIG. 8 is a schematic structural diagram of a data processing apparatus according to an embodiment of the present application; and

FIG. 9 is a schematic structural diagram of an electronic device according to an embodiment of the present application.

### DETAILED DESCRIPTION OF EMBODIMENTS

There are some differences between the foregoing two technologies of image understanding and image generation, thus different models may be used to implement the different technologies. However, in some scenarios (such as a scenario with limited resources), these scenarios may have a requirement for implementing the two technologies by using a same machine learning model.

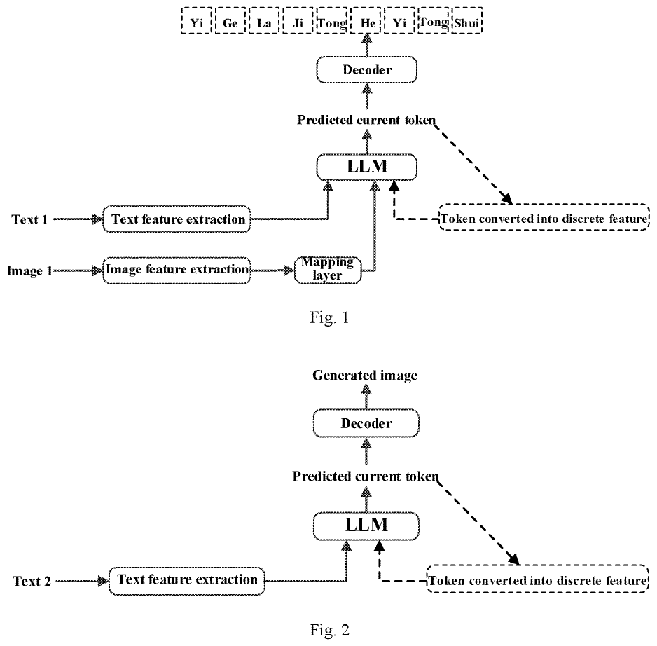

It is found through research that in some scenarios, image understanding may be implemented by using a decoder-only autoregressive model structure and a generation paradigm of next-token prediction. As an example, as shown in FIG. 1, an implementation process of image understanding may specifically be as follows: after a user provides an image 1 and a text 1 (such as a text “What is next to the chair in the image”), text feature extraction is first performed on the text 1 to obtain a text feature of the text 1, and image feature extraction is performed on the image 1 to obtain an image feature of the image 1; then, the image feature is mapped, by using a mapping layer (the mapping layer shown in FIG. 1), to a feature space to which the text feature belongs, to obtain a mapped feature, so that the mapped feature may describe, in the feature space, semantic information carried by the image 1; and finally, the mapped feature and the text feature are input to a large language model (LLM), so that the LLM may perform a first-round prediction based on the two features, to obtain a prediction result (a token of a Chinese character “Yi(-)” shown in FIG. 1) of the first-round prediction, so that the prediction result of the first-round prediction may be provided to the LLM subsequently in a specific manner (such as a manner of converting the token into a discrete feature), to enable the LLM to perform a second-round prediction, to obtain a prediction result (a token of a Chinese character “Ge ( [symbol] )” shown in FIG. 1) of the second-round prediction, . . . (reasoning in sequence), until after last-round prediction is completed, these prediction results are decoded by using a decoder, to obtain a generated text (a text “Yi Ge La Ji Tong He Yi Tong Shui (- [symbol] )” shown in FIG. 1, which means a trash can and a bucket of water).

It should be noted that the present application does not limit an implementation of the foregoing text feature extraction. For example, the text feature extraction may be implemented by using byte pair encoding (BPE) in the LLM and a vocabulary (also referred to as a text codebook) in the LLM. In addition, the present application also does not limit an implementation of the foregoing image feature extraction. For example, the image feature extraction may be implemented by using a visual encoder.

It should be further noted that a token is a symbol, so that the token is used to represent a basic unit (such as a word in a text, an image block in an image, or an image at a specific scale) in specific data. For example, the token may be implemented by using an index in a dictionary (such as a vocabulary or a specific codebook), so that the token may represent an entry (some or all of a word, an image, a discrete feature, or the like) indicated by the token in the dictionary to participate in some data processing processes.

It is further found through research that in some scenarios, image generation may be implemented by using a diffusion model. Input data of the diffusion model is a continuous feature, but input data of the machine learning model (such as the foregoing LLM) used to implement image understanding is a discrete feature. Therefore, the two technologies of image generation and image understanding need to be performed separately in isolation, which limits the application ranges of the two technologies.

It is further found through research that in an attempt to overcome the above problem, an implementation of image generation is proposed. In this implementation, image generation is also implemented by using the decoder-only autoregressive model structure and the generation paradigm of next-token prediction. As an example, as shown in FIG. 2, an implementation process of image understanding may specifically be as follows: after a user provides a text 2 (the text “A puppy is playing happily on the beach”), text feature extraction is first performed on the text 2 to obtain a text feature of the text 2; and then the text feature is input to the LLM, so that the LLM may perform a first-round prediction based on the text feature, to obtain a prediction result (a token of a first image block in the generated image shown in FIG. 2) of the first-round prediction, so that the prediction result of the first-round prediction may be provided to the LLM subsequently in a specific manner (such as a manner of converting the token into a discrete feature), to enable the LLM to perform a second-round prediction, to obtain a prediction result (a token of a second image block in the generated image shown in FIG. 2) of the second-round prediction, . . . (reasoning in sequence), until after last-round prediction is completed, these prediction results are processed by using a decoder, to obtain a generated image (the generated image shown in FIG. 2).

It is further found through research that in the solution in the foregoing paragraph, although the input data of the machine learning model (such as the LLM) used to implement image generation is also a discrete feature, there are still some differences between the two technologies of image generation and image understanding, such as different types to which the input data belongs, different information represented by the discrete features of the images (such as semantic-level information in FIG. 1 and pixel-level information in FIG. 2), and different types to which the final generated data belongs. Therefore, it is difficult to implement the two technologies by using a same machine learning model.

Based on the foregoing research, to overcome the above difficulty, the present application provides a data processing method. The method includes: after at least one piece of data (for example, a text and/or an image that is provided by a user and that is used to describe a current requirement) is obtained, first, for any piece of data of the at least one piece of data, if the piece of data is a text, an index determination result (such as a text token) of the piece of data is determined according to a text codebook that is used to describe a correspondence between different indices and discrete features of different texts; or if the piece of data is an image, an index determination result (such as an image token) of the piece of data is determined according to an image codebook that is used to describe a correspondence between different indices and discrete features of different images. In this way, various types of data may be converted into the same type of data (such as tokens), which is conducive to eliminating an impact caused by different data types, so that a discrete feature matching the index determination result of the piece of data may be obtained from a dictionary of a target model subsequently, and the discrete feature may represent information carried by the piece of data. In this way, a process of obtaining discrete features of different types of data may be unified as much as possible by using the dictionary; and then, prediction processing is performed by using the target model on the discrete feature obtained by using the dictionary, to obtain an index prediction result, so that the index prediction result is used to indicate a usage probability of each index in an index sequence of the dictionary, and an index with a largest usage probability indicated by the index prediction result is an index corresponding to a certain text or an index corresponding to a certain image. Therefore, a discrete feature indicated by the index with the largest usage probability in the dictionary may represent information carried by prediction data (for example, a text or a new image that meets the requirement) generated for the at least one piece of data, so that the prediction data may be generated subsequently based on the discrete feature. In this way, a generation process of different types of data may be unified by using the dictionary.

It may be learned that because the dictionary of the target model is constructed according to the text codebook and the image codebook, and the length of the index sequence of the dictionary is a sum of the number of indices in the text codebook and the number of indices in the image codebook, the dictionary may describe the correspondence between the indices and the discrete features recorded by the two codebooks. Therefore, when the target model is used, the dictionary may be used to unify, as much as possible, processes (such as the process of obtaining discrete features and the generation process) related to various types of data, so that the target model may flexibly process various types of data and flexibly generate various types of data. This enables the target model to ignore differences between image understanding and image generation (such as differences between processed data and differences between generated data) as much as possible, thereby ensuring that the target model may implement the two technologies of image understanding and image generation in a unified manner.

Thus, compared with the related art, the present application has at least the above advantages.

In addition, the present application does not limit an execution body of the data processing method. For example, the method may be applied to a terminal device or a server. For another example, the method may alternatively be implemented by using a data interaction process between a terminal device and a server. The terminal device may be a smartphone, a computer, a personal digital assistant (PDA), a tablet computer, or the like. The server may be an independent server, a cluster server, or a cloud server.

To enable persons skilled in the art to better understand the solutions of the present application, the following clearly and completely describes the technical solutions in the embodiments of the present application with reference to the drawings in the embodiments of the present application. It is clear that the described embodiments are merely some rather than all of the embodiments of the present application. All other embodiments obtained by a person of ordinary skill in the art based on the embodiments of the present application without creative efforts shall fall within the scope of protection of the present application.

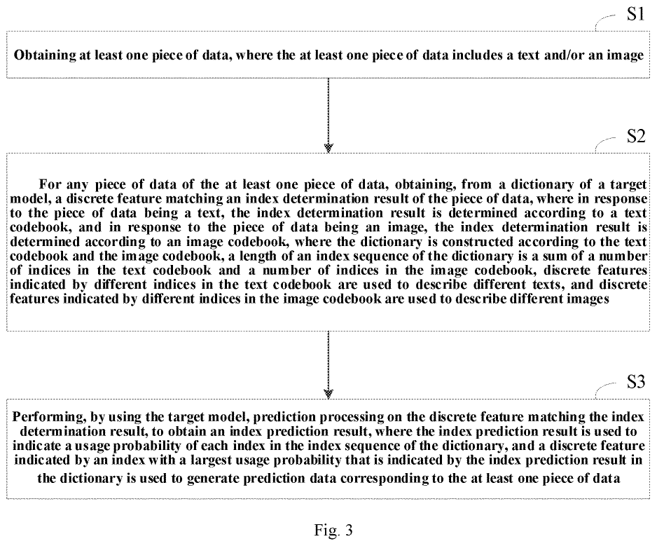

To better understand the technical solutions provided in the present application, the following first describes the data processing method provided in the present application with reference to some drawings. As shown in FIG. 3, a data processing method according to an embodiment of the present application includes S1 to S3.

S1: obtaining at least one piece of data, where the at least one piece of data includes a text and/or an image.

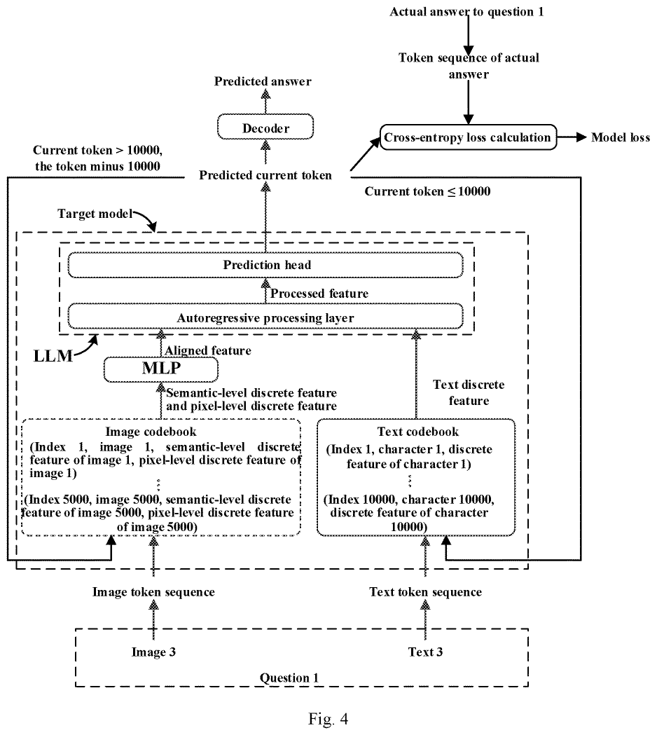

The at least one piece of data is data that needs to be processed when a specific task (such as the task of image understanding or the task of image generation) is performed, for example, data such as an image 3 and a text 3 that are shown in FIG. 4, so that the at least one piece of data may describe a requirement that needs to be satisfied in a current processing process, for example, a specific requirement for image understanding or a specific requirement for image generation. For ease of understanding, description is provided below with reference to some examples.
Example 1: In some scenarios, such as a multimodal understanding scenario, the at least one piece of data may include a text (for example, a text “What is next to the chair in the image” or the text 3 shown in FIG. 4) and an image (such as the image 3 shown in FIG. 4), so that the at least one piece of data may describe what understanding needs to be performed on the image in the current processing process.
Example 2: In some scenarios, such as a text-to-image generation scenario, the at least one piece of data may include only a text (for example, a text “A puppy is playing happily on the beach”), so that the at least one piece of data may describe what image needs to be generated in the current processing process.
Example 3: In some scenarios, such as an image reconstruction scenario or an image inpainting scenario, the at least one piece of data may include only an image (for example, a low-quality image or an image with defects), so that the at least one piece of data may describe that a better image (such as a high-quality image or a defect-free image) needs to be reconstructed for the image in the current processing process.
Example 4: In some scenarios, such as an image adjustment scenario (such as a mouth shape modification scenario, a style adjustment scenario, a painting style adjustment scenario, or a person replacement scenario), the at least one piece of data may include a text and an image, so that the at least one piece of data may describe what processing needs to be performed on the image in the current processing process.

In addition, the present application does not limit an implementation of S1. For example, when S1 to S3 are used to perform a specific task (such as the task of image understanding or the task of image generation), S1 may specifically be: obtaining at least one piece of data provided by a user for a current task, so that the at least one piece of data may describe a processing requirement of the current task.

For another example, when S1 to S3 are used to implement a model training process, S1 may specifically be: first randomly selecting one piece of training data (training data including a question 1 and an actual answer to the question 1 that is shown in FIG. 4) from a pre-built training database; and then using data (such as the question 1 shown in FIG. 4) that exists in the training data and that needs to be processed as the at least one piece of data.

It should be noted that the present application does not limit a manner of building the foregoing training database. For example, the training database may be manually built by a related person. For another example, to better improve a training effect, a process of building the training database may include: integrating training data for image understanding, training data for image generation, and some pure text conversation data to obtain the training database, so that the training database may describe, as comprehensively as possible, requirements for data generation in different scenarios, thereby enabling a model obtained based on the training database to have better performance. The training data for image understanding is training data used when a machine learning model learns how to implement image understanding. The training data for image generation is training data used when a machine learning model learns how to implement image generation. The pure text conversation data includes at least one round of question and answer.

It should be further noted that the present application does not limit the implementation of the foregoing integration. For example, the integration may specifically be: unifying the training data for image understanding, the training data for image generation, and the some pure text conversation data into a dialogue form. For example, when the training data for image understanding includes a text prompt, an image prompt, and a target text (for example, the text “a trash can and a bucket of water”), a question is constructed by using the text prompt and the image prompt, and an answer is constructed by using the target text. In this way, the training data may be converted into the dialogue form <question, answer>. For another example, when the training data for image generation includes a text prompt (for example, the text “A puppy is playing happily on the beach”) and a target image (such as an image expected to be finally generated), a question is constructed by using the text prompt, and an answer is constructed by using the target image. In this way, the training data may be converted into the dialogue form.

It may be learned that in a possible implementation, the at least one piece of data in S1 may be a question in any dialogue selected from the training database, so that a predicted answer to the question may be obtained subsequently through the processes shown in S2 and S3.

S2: for any piece of data of the at least one piece of data, obtaining, from a dictionary of a target model, a discrete feature matching an index determination result of the piece of data, where in response to the piece of data being a text, the index determination result is determined according to a text codebook, and in response to the piece of data being an image, the index determination result is determined according to an image codebook, where the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images.

The ith piece of data is any piece of data of the at least one piece of data, where i is a positive integer, and i is less than or equal to the number of pieces of data in the at least one piece of data.

The index determination result of the ith piece of data is a result obtained by performing token conversion processing on the ith piece of data, so that the index determination result may represent the ith piece of data to participate in related processing.

In addition, for the ith piece of data, if the ith piece of data is a text, the index determination result of the ith piece of data is determined according to the text codebook (the text codebook shown in FIG. 4); or if the ith piece of data is an image, the index determination result of the ith piece of data is determined according to the image codebook (the image codebook shown in FIG. 4). The text codebook is used to record a correspondence between indices of a plurality of texts (such as a plurality of characters or words) and discrete features of the plurality of texts, so that the discrete features indicated by different indices in the text codebook are used to describe different texts. The image codebook is used to record a correspondence between indices of a plurality of images and discrete features (such as semantic-level discrete features and/or pixel-level discrete features) of the plurality of images, so that the discrete features indicated by different indices in the image codebook are used to describe different images.

It should be noted that the present application does not limit an implementation of the text codebook. For example, the text codebook may be implemented by using any codebook that may describe a correspondence between indices (such as tokens of different characters or tokens of different words) of different texts and discrete features of the different texts, such as a text codebook in the LLM or the text codebook shown in FIG. 4.

It should be further noted that the present application does not limit an implementation of the image codebook. For example, the image codebook may be implemented by using any codebook that may describe a correspondence between indices of different images and discrete features (such as semantic-level discrete features and/or pixel-level discrete features) of the different images, such as the image codebook shown in FIG. 4.

It may be learned that in a possible implementation, the discrete feature indicated by each index in the image codebook may include a semantic-level discrete feature and a pixel-level discrete feature, so that each index in the image codebook may describe, as comprehensively as possible, information carried by a corresponding image, thereby ensuring that both the semantic-level information and the pixel-level information of the image may be referred to when different tasks (such as the task of image understanding or the task of image generation) are performed, and a defect caused by referring to only single-type information when the tasks are performed may be effectively avoided. This may better implement the unification of image understanding and image generation. The semantic-level discrete feature is used to describe semantic-level information (for example, information such as an image layout structure) carried by an image. The pixel-level discrete feature is used to describe pixel-level information (such as information such as color distribution) carried by an image.

In addition, the present application does not limit a manner of obtaining the index determination result of the ith piece of data. For example, the index determination result may be obtained by using a pre-built index converter (tokenizer). It may be learned that in a possible implementation, if the ith piece of data is a text, token conversion processing is performed on the ith piece of data by using the tokenizer configured with the text codebook, to obtain the index determination result of the ith piece of data, so that the index determination result includes an index that exists in the text codebook and that may represent the ith piece of data as accurately as possible, thereby enabling the index determination result to represent as accurately as possible the information carried by the ith piece of data; or if the ith piece of data is an image, the ith piece of data is processed by using the tokenizer configured with the image codebook, to obtain the index determination result of the ith piece of data, so that the index determination result includes an index that exists in the image codebook and that may represent the ith piece of data as accurately as possible, thereby enabling the index determination result to represent as accurately as possible the information carried by the ith piece of data. It should be noted that the present application does not limit a manner of building the tokenizer.

In addition, the present application does not limit an implementation of the index determination result of the ith piece of data. For example, the index determination result may include at least one index (such as a token sequence). It may be learned that in a possible implementation, if the ith piece of data is a text, the index determination result of the ith piece of data may include an index corresponding to each character (or each word) in the ith piece of data in the text codebook; or if the ith piece of data is an image, the index determination result of the ith piece of data may include an index corresponding to each image block (or each image at a specific scale) in the ith piece of data in the image codebook.

The dictionary of the target model is a dictionary that is configured for the model and that is used to assist the model in performing some processing processes (such as a prediction process). The dictionary is used to describe some indices and entries (such as discrete features) indicated by the indices. The dictionary is constructed according to the text codebook and the image codebook, and the length of the index sequence of the dictionary (that is, the number of indices in the dictionary) is the sum of the number of indices in the text codebook and the number of indices in the image codebook. Therefore, the dictionary may describe the correspondence described by the two codebooks, so that processes related to different types of data may be unified as much as possible by using the dictionary when the model is used, and differences caused by different data types may be eliminated as much as possible.

It should be noted that the index sequence of the dictionary is used to describe, in a specific order, all indices that appear in the dictionary, so that the index sequence may represent which indices appear in the dictionary, and the length of the index sequence may represent the number of indices in the dictionary.

In addition, the present application does not limit an implementation of the dictionary of the target model. For example, the dictionary may include the text codebook and the image codebook.

In addition, the present application does not limit the implementation of S2. For example, S2 may specifically be: after the index determination result of the ith piece of data (such as a text or an image) is obtained, searching the dictionary of the target model for the discrete feature matching the index determination result, and using the discrete feature as the discrete feature corresponding to the ith piece of data, so that the discrete feature is a feature that is determined by using the dictionary and that is used to describe as accurately as possible the information carried by the ith piece of data, thereby enabling the discrete feature to represent the ith piece of data to participate in other processing processes in the model. Herein, i is a positive integer, and i is less than or equal to the number of pieces of data in the at least one piece of data.

It should be noted that the present application does not limit the implementation of the “searching” shown in the foregoing paragraph. For example, when the dictionary of the target model includes the text codebook and the image codebook, the “searching” may specifically be: first, selecting, from the dictionary, a codebook matching a data type (such as a text or an image) of the ith piece of data; and then, searching the matched codebook for the discrete feature indicated by the index determination result of the ith piece of data, and using the discrete feature as the discrete feature matching the index determination result of the ith piece of data.

It may be learned from the foregoing related content of S2 that after the at least one piece of data is obtained, if the at least one piece of data includes a text, first, the index determination result (the text token sequence shown in FIG. 4) of the text is determined, so that the index determination result may describe, in the manner of tokens, the semantic information carried by the text; and then, the discrete feature matching the index determination result of the text is obtained from the dictionary of the target model, so that the discrete feature may represent as accurately as possible the semantic information carried by the text. If the at least one piece of data includes an image, first, the index determination result (the image token sequence shown in FIG. 4) of the image is determined, so that the index determination result may describe, in the manner of tokens, information (such as pixel-level information and semantic-level information) carried by the image; and then, the discrete feature matching the index determination result of the image is obtained from the dictionary, so that the discrete feature may represent as accurately as possible the information carried by the image, so that a feedback (such as a predicted answer) predicted for the at least one piece of data may be obtained subsequently by performing the prediction processing on the discrete features by using the target model.

S3: performing, by using the target model, prediction processing on the discrete feature matching the index determination result, to obtain an index prediction result, where the index prediction result is used to indicate a usage probability of each index in the index sequence of the dictionary, and a discrete feature indicated by an index with a largest usage probability indicated by the index prediction result in the dictionary is used to generate prediction data corresponding to the at least one piece of data.

The target model is a machine learning model that is configured with the dictionary and that may unify image understanding and image generation. It should be noted that the present application does not limit an implementation of the target model. For example, the target model may be implemented by using a decoder-only autoregressive model structure. It may be learned that in a possible implementation, the target model may be built on the basis of the LLM, so that the target model at least has a function that the LLM itself has.

The index prediction result is obtained by the target model by performing some processing on the discrete feature corresponding to the at least one piece of data, so that the index prediction result may represent information carried by the feedback (such as the predicted answer) predicted for the at least one piece of data.

In addition, because the index prediction result is used to indicate the usage probability of each index in the index sequence of the dictionary of the target model, when the discrete feature indicated by the index with the largest usage probability indicated by the index prediction result in the dictionary is used to describe a specific text (such as a specific character or word), the prediction data generated based on the index prediction result includes the text; and when the discrete feature indicated by the index with the largest usage probability in the dictionary is used to describe a specific image, the prediction data generated based on the index prediction result includes the image. Therefore, the index prediction result generated by the target model may represent not only a text, but also an image. This enables the target model to unify, as much as possible, the generation process of different types of data, thereby eliminating, as much as possible, differences caused by different data types.

The prediction data corresponding to the at least one piece of data is a feedback (such as a text or an image) generated by using the target model for the at least one piece of data, so that the prediction data may satisfy a requirement (such as an image understanding requirement or an image generation requirement) described by the at least one piece of data as much as possible.

In addition, the present application does not limit the process of generating the prediction data. For example, the process may specifically be: first, performing, by the target model, a first-round prediction based on the discrete feature corresponding to the at least one piece of data, to obtain an index prediction result of the first-round prediction (such as a token of a first character, a token of a first image block, or a token of an image at a first scale); then, providing, to the target model, a discrete feature indicated by the index prediction result of the first-round prediction in the dictionary of the target model, to enable the target model to perform a second-round prediction, to obtain an index prediction result of the second-round prediction (such as a token of a second character, a token of a second image block, or a token of an image at a second scale); . . . (and so on); and after last-round prediction is performed, performing, by a decoder, processing on all index prediction results, to obtain the prediction data corresponding to the at least one piece of data, so that the prediction data may satisfy the requirement described by the at least one piece of data as much as possible.

It should be noted that for two adjacent rounds of prediction, the index prediction results of the two rounds of prediction may be used to represent a same type of data, or may be used to represent different types of data, so that the prediction data generated for the at least one piece of data based on the target model may be a pure text, a pure image, or text-image mixed data (such as data in which some images are interspersed between some characters).

It may be learned from the foregoing related content of S1 to S3 that for the target model provided in the present application for unifying the two functions of image understanding and image generation, after at least one piece of data (for example, a text and/or an image that is provided by a user and that is used to describe a current requirement) is obtained, first, for any piece of data of the at least one piece of data, if the piece of data is a text, an index determination result (such as a text token) of the piece of data is determined according to the text codebook that is used to describe a correspondence between different indices and discrete features of different texts; or if the piece of data is an image, an index determination result (such as an image token) of the piece of data is determined according to the image codebook that is used to describe a correspondence between different indices and discrete features of different images. In this way, various types of data may be converted into the same type of data (such as tokens), which is conducive to eliminating an impact caused by different data types, so that the discrete feature matching the index determination result of the piece of data may be obtained from the dictionary of the target model subsequently, and the discrete feature may represent information carried by the piece of data. In this way, the process of obtaining discrete features of different types of data may be unified as much as possible by using the dictionary. Then, the prediction processing is performed by using the target model on the discrete feature obtained by using the dictionary, to obtain the index prediction result, so that the index prediction result is used to indicate the usage probability of each index in the index sequence of the dictionary, and the index with the largest usage probability indicated by the index prediction result is an index corresponding to a certain text or an index corresponding to a certain image. Therefore, the discrete feature indicated by the index with the largest usage probability in the dictionary may represent information carried by the prediction data (for example, a text or a new image that meets the requirement) generated for the at least one piece of data, so that the prediction data may be generated subsequently based on the discrete feature. In this way, the generation process of different types of data may be unified by using the dictionary.

It may be learned that because the dictionary of the target model is constructed according to the text codebook and the image codebook, and the length of the index sequence of the dictionary is the sum of the number of indices in the text codebook and the number of indices in the image codebook, the dictionary may describe the correspondence between the indices and the discrete features recorded by the two codebooks. Therefore, when the target model is used, the dictionary may be used to unify, as much as possible, the processes (such as the process of obtaining discrete features and the generation process) related to various types of data, so that the target model may flexibly process various types of data and flexibly generate various types of data. This enables the target model to ignore the differences between image understanding and image generation (such as the differences between the processed data and the differences between the generated data) as much as possible, thereby ensuring that the target model may implement the two technologies of image understanding and image generation in a unified manner.

In addition, to better reduce the impact of the data type when the target model is used, the present application further provides a possible implementation of the dictionary of the target model. In this implementation, the index sequence of the dictionary includes a first index set (such as indices 1 to 10000) and a second index set (such as indices 10001 to 15000). An arrangement position of each index in the first index set precedes that of each index in the second index set in the index sequence. The first index set includes indices in a codebook (such as a text codebook) corresponding to the first index set. The second index set is obtained by separately adding a preset offset (such as 10000) to indices in a codebook (such as an image codebook) corresponding to the second index set. The preset offset is used to indicate a number of indices in the codebook corresponding to the first index set. The codebook corresponding to the first index set is the text codebook, and the codebook corresponding to the second index set is the image codebook; or the codebook corresponding to the first index set is the image codebook, and the codebook corresponding to the second index set is the text codebook, so that the dictionary may use a same indexing mechanism to indicate the discrete features of various types of data. This may effectively overcome defects (such as different query manners and low query efficiency for different types of data) caused by the discrete features of different types of data respectively using different indexing mechanisms, thereby facilitating better weakening of the impact of the data type, and enabling better improvement of the unification effect of the target model on image understanding and image processing.

It should be noted that the first index set is used to record indices that exist in the index sequence of the dictionary of the target model, that are arranged in front positions, and that come from the codebook corresponding to the first index set. The codebook corresponding to the first index set is a codebook that needs to be expanded. The present application does not limit the codebook corresponding to the first index set. For example, the codebook corresponding to the first index set may be implemented by using an originally configured codebook (such as the text codebook in the LLM) in the target model. It may be learned that in a possible implementation, the codebook corresponding to the first index set belongs to the configuration information of the target model.

It should be further noted that the second index set is used to record indices that exist in the index sequence of the dictionary of the target model, that are arranged in rear positions, and that come from the codebook corresponding to the second index set. The codebook corresponding to the second index set is a codebook that needs another codebook to provide an expansion content. The present application does not limit the codebook corresponding to the second index set. For example, the codebook corresponding to the second index set does not belong to the configuration information of the target model.

It should be further noted that the present application does not limit the implementation of the dictionary shown in the foregoing three paragraphs. For example, the dictionary may include the first index set, the discrete features indicated by the indices in the first index set, the second index set, and the discrete features indicated by the indices in the second index set, so that the discrete features indicated by the indices may be subsequently queried by using the dictionary. For another example, to better reduce the extent of change, the dictionary may include the first index set and the second index set, so that the dictionary may describe an index correspondence between the indices in the dictionary and existing codebooks (such as the text codebook and the image codebook), so that the discrete features indicated by the indices may be subsequently queried jointly by using the dictionary, the text codebook, and the image codebook. For ease of understanding, the following describes some examples.
Example 1: In some cases (for example, the text codebook belongs to the configuration information of the target model, but the image codebook does not belong to the configuration information of the target model), a method for constructing the dictionary of the target model may include: first, separately adding indices (such as indices 1 to 5000) in the image codebook to a number of indices (such as 10000) in the text codebook to obtain a processed codebook, so that each index (such as indices 10001 to 15000) in the processed codebook is greater than each index in the text codebook; and then, adding content (such as all indices and discrete features indicated by the indices) in the processed codebook to the text codebook to obtain the dictionary, so that the dictionary may include content in the text codebook and the content in the processed codebook. Therefore, the dictionary may describe a plurality of indices (such as indices 1 to 15000) that are arranged in sequence and the discrete feature indicated by each of the plurality of indices. In this way, a dictionary with a unified indexing mechanism may be constructed by expanding the text codebook by using the image codebook with adjusted indices, so that various types of data may be represented by using the indices in the dictionary in the subsequent use of the target model, thereby facilitating better weakening of the impact of the data type.
Example 2: In some cases (for example, the image codebook belongs to the configuration information of the target model, but the text codebook does not belong to the configuration information of the target model), a method for constructing the dictionary of the target model may include: first, separately adding indices (such as indices 1 to 10000) in the text codebook to a number of indices (such as 5000) in the image codebook to obtain a processed codebook, so that each index (such as indices 5001 to 15000) in the processed codebook is greater than each index in the image codebook; and then, adding content in the processed codebook to the image codebook to obtain the dictionary, so that the dictionary may include content in the image codebook and the content in the processed codebook. Therefore, the dictionary may describe a plurality of indices (such as indices 1 to 15000) that are arranged in sequence and the discrete feature indicated by each of the plurality of indices. In this way, a dictionary with a unified indexing mechanism may be constructed by expanding the image codebook by using the text codebook with adjusted indices, so that various types of data may be represented by using the indices in the dictionary in the subsequent use of the target model, thereby facilitating better weakening of the impact of the data type.
Example 3: In some cases, a method for constructing the dictionary of the target model may include: first, separately adding indices (such as indices 1 to 5000) in the image codebook to a number of indices (such as 10000) in the text codebook to obtain an addition result (such as indices 10001 to 15000); and then, constructing the dictionary according to the addition result and indices in the text codebook, so that the dictionary includes the addition result and the indices in the text codebook, so that various types of data may be represented by using the indices in the dictionary in the subsequent use of the target model, thereby facilitating better weakening of the impact of the data type.
Example 4: In some cases, a method for constructing the dictionary of the target model may include: first, separately adding indices (such as indices 1 to 10000) in the text codebook to a number of indices (such as 5000) in the image codebook to obtain an addition result (such as indices 5001 to 15000); and then, constructing the dictionary according to the addition result and indices in the image codebook, so that the dictionary includes the addition result and the indices in the image codebook, so that various types of data may be represented by using the indices in the dictionary in the subsequent use of the target model, thereby facilitating better weakening of the impact of the data type.

It is found through research that for the dictionary of the target model shown in the foregoing two paragraphs, because the discrete features indicated by some indices in the dictionary are stored in the text codebook, and the discrete features indicated by some other indices are stored in the image codebook, to better meet query requirements in different tasks, the present application further provides a usage of the dictionary. In this usage, when the index sequence of the dictionary includes the first index set and the second index set, a process of using the dictionary may include: after the index prediction result (such as the index prediction result in S3) obtained by the target model through the prediction processing is obtained, in response to the index with the largest usage probability indicated by the index prediction result belonging to the first index set, the discrete feature indicated by the “index with the largest usage probability” in the dictionary is obtained by searching the codebook (such as the text codebook) corresponding to the first index set for the discrete feature indicated by the “index with the largest usage probability”; or in response to the “index with the largest usage probability” belonging to the second index set, the discrete feature indicated by the “index with the largest usage probability” in the dictionary is obtained by searching the codebook (such as the image codebook) corresponding to the second index set for the discrete feature indicated by a difference between the “index with the largest usage probability” and the preset offset (such as 10000). In this way, information query may be implemented by jointly using the dictionary, the text codebook, and the image codebook, so that the query process of different types of data may be unified as much as possible while reducing the extent of change.

It may be learned that when the dictionary of the target model includes the first index set and the second index set, after the index prediction result obtained by the target model through the prediction processing is obtained, it is first determined whether the index with the largest usage probability indicated by the index prediction result exceeds the preset offset (such as 10000). If the index does not exceed the preset offset, it may be determined that the “index with the largest usage probability” belongs to the first index set, and it may be determined that the “index with the largest usage probability” is an index in the codebook (such as the text codebook) corresponding to the first index set. Therefore, the discrete feature corresponding to the “index with the largest usage probability” may be directly searched for in the codebook corresponding to the first index set, and used as the discrete feature indicated by the “index with the largest usage probability” in the dictionary. If the index exceeds the preset offset, it may be determined that the “index with the largest usage probability” belongs to the second index set, and it may be determined that the difference between the “index with the largest usage probability” and the preset offset is an index in the codebook (such as the image codebook) corresponding to the second index set. Therefore, the discrete feature corresponding to the difference may be directly searched for in the codebook corresponding to the second index set, and used as the discrete feature indicated by the “index with the largest usage probability” in the dictionary. In this way, the query process of different types of data may be unified as much as possible by reusing the existing codebooks.

It is found through research that for the dictionary of the target model shown in the foregoing four paragraphs, because the discrete features indicated by the indices in the dictionary are all stored in the existing codebooks (such as the text codebook and the image codebook), to simplify the manner of obtaining the discrete features, the present application further provides a possible implementation of S2. Specifically, for any piece of data of the at least one piece of data, in response to the piece of data being a text, the discrete feature (the text discrete feature shown in FIG. 4) indicated by the index determination result of the piece of data is searched for in the text codebook, and used as the discrete feature matching the index determination result of the piece of data; or in response to the piece of data being an image, the discrete feature (the semantic-level discrete feature and the pixel-level discrete feature shown in FIG. 4) indicated by the index determination result of the piece of data is searched for in the image codebook, and used as the discrete feature matching the index determination result of the piece of data. In this way, the process of obtaining discrete features may be simplified as much as possible by reusing the existing codebooks, thereby facilitating efficiency improvement.

It may be learned that as shown in FIG. 4, when the discrete features indicated by some indices in the dictionary of the target model are stored in the text codebook, and the discrete features indicated by some other indices are stored in the image codebook, for any piece of data (such as the ith piece of data) of the at least one piece of data, after the index determination result of the piece of data is obtained, if the piece of data is a text, the discrete feature corresponding to the index determination result (the text token sequence shown in FIG. 4) of the piece of data is searched for in the text codebook, and used as the discrete feature matching the index determination result of the piece of data; or if the piece of data is an image, the discrete feature corresponding to the index determination result (the image token sequence shown in FIG. 4) of the piece of data is searched for in the image codebook, and used as the discrete feature matching the index determination result of the piece of data. In this way, the procedure may be simplified, thereby facilitating efficiency improvement.

It is found through research that the discrete features in the text codebook are respectively used to describe texts (such as characters or words) in a text feature space (such as a one-dimensional space), but the discrete features in the image codebook are respectively used to describe images (such as image blocks or images at various scales) in an image feature space (such as a two-dimensional space), so that the discrete features in the two codebooks respectively belong to different feature spaces. Therefore, when the discrete features in the two codebooks need to be synthesized to perform some processing (such as the prediction processing in S3), some adverse effects are caused by the different feature spaces, which in turn affects the processing effect.

Based on the foregoing research, to overcome the above problem, the present application provides an implementation of the target model. In this implementation, when the discrete feature indicated by each index in the text codebook belongs to the text feature space, the mapping layer in the target model is used to map the discrete feature (the semantic-level discrete feature and the pixel-level discrete feature shown in FIG. 4) searched for from the image codebook to the text feature space, so that the output data of the mapping layer and the feature (the text discrete feature shown in FIG. 4) searched for from the text codebook subsequently both participate in the prediction processing (the prediction processing implemented by the LLM shown in FIG. 4) shown in S3. In this way, the discrete feature in the image feature space may be mapped to the text feature space, so that features in different feature spaces may be subjected to feature dimension alignment, and the impact caused by feature space inconsistency may be effectively overcome, to better improve the prediction effect. It should be noted that the present application does not limit an implementation of the mapping layer. For example, the mapping layer may be implemented by using any neural network that may map a feature in one feature space to another feature space, such as any linear layer or multilayer perceptron (MLP).

It may be learned that for the target model, when the first data includes a text and an image, after the discrete feature matching the index determination result of the text and the discrete feature matching the index determination result of the image are obtained from the dictionary of the target model, because the two discrete features respectively belong to different feature spaces, the “discrete feature matching the index determination result of the image” may be mapped, by using the mapping layer in the target model, to the text feature space to obtain the mapped feature, so that the mapped feature may describe information (such as semantic-level information or pixel-level information) carried by the image in the text feature space, and the mapped feature and the “discrete feature matching the index determination result of the text” belong to the same feature space. Therefore, the mapped feature and the “discrete feature matching the index determination result of the text” are in the feature dimension alignment state, so that the target model may perform the prediction processing on the mapped feature and the “discrete feature matching the index determination result of the text” subsequently to obtain the index prediction result. In this way, the impact caused by feature space inconsistency may be effectively overcome, to better improve the prediction effect.

In addition, to better weaken the impact of the data type, the target model may include one prediction head (the prediction head shown in FIG. 4), so that the prediction head may participate in the prediction processing (the prediction processing implemented by the LLM shown in FIG. 4) shown in S3, and the index prediction result shown in S3 is output by the prediction head. The index prediction result may describe the usage probability of the indices of the plurality of types of data (such as a text and an image), so that the prediction head that outputs the index prediction result has the prediction capability for the plurality of types of data, and the impact (such as differentiating the generation process of different types of data) caused by using different prediction heads to separately predict different types of data may be effectively overcome, so that the generation procedure of different types of data may be better unified.

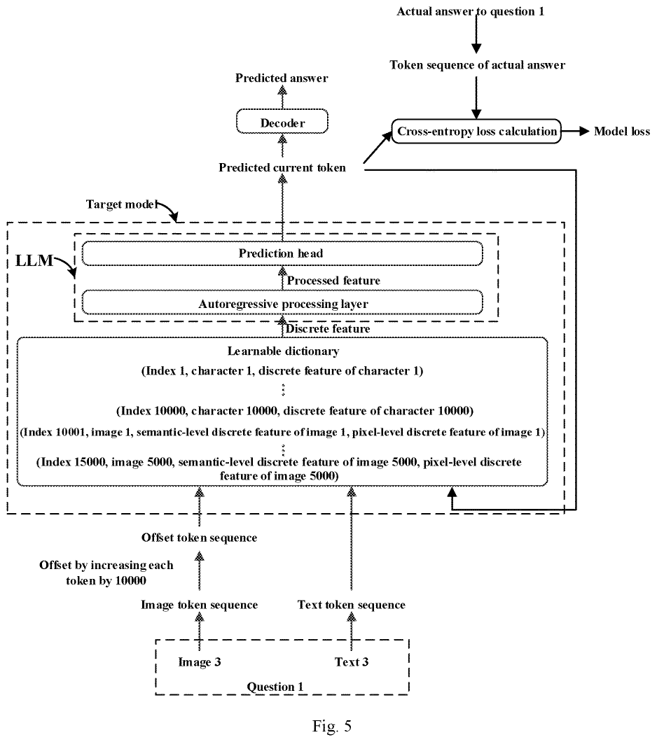

It should be noted that the present application does not limit the implementation of the prediction head. For example, the prediction head may be implemented by using any network structure that may convert a feature (the processed feature shown in FIG. 4 or FIG. 5) into a prediction result. For another example, when the target model is built on the basis of the LLM, because a number of indices that may be predicted by the prediction head in the LLM is a number of indices of the text codebook in the LLM, the prediction head in the target model may be obtained by extending the prediction head in the LLM, so that a number of indices that may be predicted by the prediction head in the target model is expanded to a sum of the number of indices of the text codebook and a number of indices of the image codebook.

It may be learned that in a possible implementation, the target model may include the mapping layer (the MLP shown in FIG. 4), the prediction head (the prediction head shown in FIG. 4) obtained by extending the prediction head in the LLM, and another part (the autoregressive processing layer shown in FIG. 4) other than the prediction head in the LLM. It should be noted that the present application does not limit the implementation of the autoregressive processing layer. For example, the autoregressive processing layer may be implemented by using an auto-regressive transformer.

It may be learned from the foregoing related content of the target model that as shown in FIG. 4, when the at least one piece of data includes a text 3 and an image 3, if the target model includes the mapping layer and the LLM (the LLM shown in FIG. 4) with the extended prediction head, the working principle of the target model includes: after the index determination result (the text token sequence shown in FIG. 4) of the text 3 and the index determination result (the image token sequence shown in FIG. 4) of the image 3 are obtained, first, the discrete feature (the semantic-level discrete feature and the pixel-level discrete feature shown in FIG. 4) corresponding to the index determination result of the image 3 is searched for from the image codebook, and the discrete feature (the text discrete feature shown in FIG. 4) corresponding to the index determination result of the text 3 is searched for from the text codebook; then, the “discrete feature corresponding to the index determination result of the image 3” is mapped, by the mapping layer, to the text feature space to obtain the output data (the aligned feature shown in FIG. 4) of the mapping layer, so that the output data may describe, in the text feature space, the information carried by the image 3; and then, the output data of the mapping layer and the “discrete feature corresponding to the index determination result of the text 3” are subjected to prediction processing by the LLM to obtain the index prediction result, so that the index with the largest usage probability indicated by the index prediction result may represent the index (the current token shown in FIG. 4) obtained through the current-round prediction, so that the prediction data (the predicted answer shown in FIG. 4) for satisfying the requirement described by the text 3 and the image 3 may be generated subsequently based on the index with the largest usage probability.

It should be noted that the present application does not limit the manner of generating the prediction data shown in the foregoing paragraph. For example, the prediction data may be specifically generated as follows: after the index prediction result is obtained through the current-round prediction, if the index with the largest usage probability indicated by the index prediction result does not exceed the preset offset (10000 shown in FIG. 4), the discrete feature corresponding to the “index with the largest usage probability” is searched for from the text codebook; or if the “index with the largest usage probability” exceeds the preset offset, the difference between the “index with the largest usage probability” and the preset offset is calculated, and the discrete feature corresponding to the difference is searched for from the image codebook, so that the discrete feature may be provided to the LLM subsequently, to enable the LLM to perform the next-round prediction. This is iteratively cycled for a plurality of rounds, until when the last-round prediction is performed, the decoder is used to perform decoding processing on the index with the largest usage probability that is generated in each round of prediction, to obtain the prediction data (the predicted answer shown in FIG. 4) for satisfying the requirement described by the text 3 and the image 3.

It is found through research that for the dictionary of the target model shown in the foregoing two paragraphs, although the dictionary may describe the discrete features of different types of data, the discrete features of different types of data respectively belong to different feature spaces, so that a feature alignment operation needs to be performed during the use of the target model, which affects the efficiency.

Based on the foregoing research, in some cases (for example, the text codebook belongs to configuration information of the target model, but the image codebook does not belong to the configuration information of the target model), to better improve the efficiency, the present application further provides a method for constructing the dictionary of the target model. The method includes the following steps 11 to 16.

Step 11: obtaining at least one index and a discrete feature indicated by each index of the at least one index, where each index of the at least one index is different from each index in the text codebook, discrete features indicated by different indices of the at least one index are used to describe different images, and the discrete feature indicated by each index of the at least one index and a discrete feature indicated by each index in the text codebook belong to a same feature space, and the discrete features indicated by different indices in the text codebook are used to describe different texts.

The at least one index refers to an index that needs to be added to the text codebook in the model to expand it when the dictionary of the target model is constructed, so that the at least one index satisfies at least the following constraints: each index of the at least one index is different from each index in the text codebook, the discrete features indicated by the different indices of the at least one index are used to describe different images, and the discrete feature indicated by each index of the at least one index and the discrete feature indicated by each index in the text codebook belong to the same feature space.

In addition, to ensure the continuity of the indices in the dictionary, the at least one index may further satisfy the following constraint: a difference between a minimum value of the at least one index and a largest index in the text codebook is 1. For example, when the text codebook includes index 1 to index 10000, the at least one index may include index 10001 to index 15000.

In addition, to ensure that the dictionary may better learn, from the image codebook, how to represent an image, the at least one index may further satisfy the following constraint: a number of indices of the at least one index is equal to a number of indices in the image codebook, so that how to describe, in the text feature space, each image described by the image codebook may be learned subsequently by iteratively updating the dictionary for a plurality of rounds.

In addition, for any index of the at least one index, the discrete feature indicated by the index is a discrete feature corresponding to the index, so that the discrete feature indicated by the index may describe information (such as semantic-level information and pixel-level information) carried by an image in the text feature space. This also ensures that the discrete feature indicated by the index and the discrete feature indicated by each index in the text codebook belong to the same feature space, and an object (such as an image) described by the discrete feature indicated by the index is different from an object (such as a text) described by the discrete feature indicated by each index in the text codebook.

In addition, the present application does not limit the manner of obtaining the discrete feature indicated by each index of the at least one index. For example, the discrete feature may be obtained through manual labeling. It may be learned that in a possible implementation, step 11 may specifically include: obtaining the at least one index, and receiving the discrete feature indicated by each index of the at least one index that is provided by a related person.

For another example, to better improve the efficiency, step 11 may specifically include: obtaining the at least one index, and randomly generating the discrete feature indicated by each index of the at least one index. This may effectively simplify the initialization processing of the discrete feature indicated by each index of the at least one index, thereby facilitating a reduction in the difficulty of obtaining data.

For still another example, to better reduce the number of updates of the dictionary, step 11 may specifically include: adding each index in the image codebook to the number of indices in the text codebook to obtain the at least one index, and separately mapping the discrete feature indicated by each index in the image codebook to the “same feature space” (such as the text feature space) to obtain the discrete feature indicated by each index of the at least one index. In this way, the initialization processing of the discrete feature indicated by each index of the at least one index may be implemented based on the image codebook, so that it may be effectively ensured that the image described by the initial value of the discrete feature indicated by each index of the at least one index is as close as possible to the image described by the image codebook, thereby ensuring that a dictionary with better quality may be obtained subsequently simply by performing a few rounds of updates.

Step 12: expanding the text codebook by using the at least one index and the discrete feature indicated by each index of the at least one index, to obtain the dictionary of the target model, so that a length of an index sequence of the dictionary is a sum of a number of indices in the text codebook and a number of indices in an image codebook, and discrete features indicated by different indices in the image codebook are used to describe different images. In this way, the initialization processing of the dictionary may be completed.

In the present application, after the at least one index and the discrete feature indicated by each index of the at least one index are obtained, the at least one index and the discrete feature indicated by each index of the at least one index may be directly added to the text codebook in a specific manner, so that the text codebook (the learnable dictionary shown in FIG. 5) after the addition includes not only the correspondence described by the text codebook before the addition, but also the correspondence between the at least one index and the discrete feature indicated by each index of the at least one index, so that the text codebook after the addition may be used as an initial value of the dictionary of the target model subsequently, to enable the initialized dictionary to describe different types of data (such as text data and image data) in the same feature space. Therefore, the feature alignment step may be omitted in the related processing procedure implemented based on the dictionary, which is conducive to better simplifying the procedure, thereby facilitating an efficiency improvement.

Step 13: obtaining the at least one piece of data and label data corresponding to the at least one piece of data, where the at least one piece of data includes a text and/or an image.

The label data corresponding to the at least one piece of data is data (the actual answer shown in FIG. 5) that is labeled in advance for the at least one piece of data (the question 1 shown in FIG. 5) and that is expected to be fed back for the at least one piece of data, so that the label data may represent data that actually satisfies the requirement described by the at least one piece of data, thereby enabling the label data to guide and affect the related processing of the at least one piece of data as a ground-truth.

In addition, the present application does not limit the implementation of step 13. For example, step 13 may specifically include: first randomly selecting one piece of training data (training data including the question 1 and the actual answer to the question 1 that is shown in FIG. 5) from a pre-built training database; and then using data (such as the question 1 shown in FIG. 5) that exists in the training data and that needs to be processed as the at least one piece of data, and using remaining data (the actual answer shown in FIG. 5) other than the data that needs to be processed in the training data as the label data corresponding to the at least one piece of data, so that the related processing of the at least one piece of data may be performed subsequently under the guidance of the label data.

It should be noted that the present application does not limit the execution time of step 13, as long as it is ensured that the execution time of step 13 is earlier than the execution time of step 14 below.

Step 14: for any piece of data of the at least one piece of data, obtaining, from the dictionary of the target model, a discrete feature matching an index determination result of the piece of data, where in response to the piece of data being a text, the index determination result is determined according to the text codebook, and in response to the piece of data being an image, the index determination result is determined according to the image codebook.

It should be noted that for the related content of step 14, refer to the related content of S2. For the sake of brevity, details are not described herein again.

In addition, to better improve the efficiency, step 14 may specifically include: for any piece of data of the at least one piece of data, in response to the piece of data being a text, searching the dictionary of the target model for a discrete feature indicated by the index determination result of the piece of data, as the discrete feature matching the index determination result of the piece of data; or in response to the piece of data being an image, adjusting the index determination result of the piece of data to obtain an adjusted index, so that the at least one index includes the adjusted index, and searching the dictionary for a discrete feature indicated by the adjusted index, as the discrete feature matching the index determination result of the piece of data. In this way, the discrete feature indicated by the index of any type of data in the same feature space may be quickly queried by using the dictionary, which is conducive to reducing the difference between the procedures for converting different types of data into the same feature space, thereby facilitating better weakening of the impact of the data type, to better implement the unification of image understanding and image generation.

It may be learned that for any piece of data of the at least one piece of data, after the piece of data is obtained, if the piece of data is a text, first, the index determination result (the text token sequence shown in FIG. 5) of the piece of data is determined according to the text codebook; and then, the discrete feature corresponding to the index determination result of the piece of data is searched for in the dictionary of the target model, and used as the discrete feature matching the index determination result of the piece of data. However, if the piece of data is an image, first, the index determination result (the image token sequence shown in FIG. 5) of the piece of data is determined according to the image codebook; and then, the index determination result of the piece of data is adjusted according to the preset offset (10000 shown in FIG. 5) to obtain the adjusted index (the offset token sequence shown in FIG. 5), so that a difference between the adjusted index and the index determination result of the piece of data is the preset offset, so that the discrete feature corresponding to the adjusted index may be searched for in the dictionary subsequently, and used as the discrete feature matching the index determination result of the piece of data. In this way, different types of data may be converted into the same feature space by using the dictionary, which is conducive to better unifying the related procedures of different types of data, thereby facilitating better weakening of the impact of the data type, to better implement the unification of image understanding and image generation.

Step 15: performing, by using the target model, prediction processing on the discrete feature matching the index determination result, to obtain an index prediction result, where the index prediction result is used to indicate a usage probability of each index in the index sequence of the dictionary of the target model, and a discrete feature indicated by an index with a largest usage probability that is indicated by the index prediction result in the dictionary is used to generate prediction data corresponding to the at least one piece of data.

It should be noted that for the related content of step 15, refer to the related content of S3. For the sake of brevity, details are not described herein again.

It may be learned from the foregoing related content of step 15 that after the discrete feature (such as the discrete feature matching the index determination result) corresponding to each piece of data of the at least one piece of data is obtained, a first-round prediction is performed by the LLM in the target model on the discrete feature, to obtain an index prediction result (such as a token of a first character, a token of a first image block, or a token of an image at a first scale) of the first-round prediction; and then, a discrete feature corresponding to the index prediction result of the first-round prediction in the dictionary of the target model is provided to the target model, to enable the target model to perform a second-round prediction, to obtain an index prediction result (such as a token of a second character, a token of a second image block, or a token of an image at a second scale) of the second-round prediction; . . . (and so on); and after last-round prediction is performed, processing is performed by the decoder on all index prediction results, to obtain the prediction data corresponding to the at least one piece of data, so that the prediction data may represent a feedback predicted by using the target model for the at least one piece of data, so that the performance (such as the quality of the dictionary of the target model) of the current target model may be measured subsequently based on the prediction data.

Step 16: updating the dictionary of the target model according to the index prediction result and an index determination result of the label data corresponding to the at least one piece of data, and continuing to perform step 13 and the subsequent steps, to implement a next-round construction process of the dictionary. This is iteratively cycled until when a preset stop condition (for example, a number of updates of the dictionary reaches a preset number threshold, a model loss of the target model is less than a preset loss threshold, or a change rate of the model loss is less than a preset change rate threshold) is met, the iterative cyclic construction process of the dictionary ends. The label data is used to indicate a ground-truth of the prediction data corresponding to the at least one piece of data. In response to the label data being a text, the index determination result of the label data is determined according to the text codebook. In response to the label data being an image, the index determination result of the label data is determined according to the image codebook.

The label data corresponding to the at least one piece of data is used to represent a feedback actually labeled for the at least one piece of data, so that the label data may be used as a ground-truth to evaluate whether the prediction data corresponding to the at least one piece of data is correct, so that the performance (such as the quality of the dictionary of the target model) of the current target model may be measured based on an evaluation result.

In addition, the present application does not limit the implementation of the foregoing evaluation. For example, the evaluation may be implemented by using any manner that may evaluate a difference between two pieces of data.

For another example, to better improve the evaluation effect, the foregoing evaluation may be implemented by using the cross-entropy loss. It may be learned that after the index prediction result is obtained, cross-entropy loss calculation may be performed according to the index prediction result and the index determination result of the label data corresponding to the at least one piece of data, to obtain a model loss (the model loss shown in FIG. 5) of the target model, so that the model loss may represent the performance (such as the quality of the dictionary of the target model) of the current target model. It should be noted that the present application does not limit a calculation manner of the model loss.

The index determination result (a token sequence of the actual answer shown in FIG. 5) of the label data corresponding to the at least one piece of data is used to represent the label data, so that the index determination result may participate in a subsequent processing procedure instead of the label data subsequently. In addition, the present application does not limit a determination manner of the index determination result. For example, the index determination result may be determined by using any method that may convert data into an index.

In addition, to better improve a learning effect of the dictionary of the target model, for the label data corresponding to the at least one piece of data, in response to the label data being a text, the index determination result of the label data is determined according to the text codebook, so that the index determination result is an index in the text codebook, and the index determination result is also an index in the dictionary expanded based on the text codebook. Therefore, the index determination result may accurately represent an index corresponding to the label data in the dictionary. Therefore, the dictionary may be directly updated according to the index determination result and the index prediction result generated by the target model for the at least one piece of data, so that the updated dictionary may better describe related information (such as an index and a discrete feature) of different types of data, so that based on the updated dictionary, the method may return to step 13 and the subsequent steps, to implement the next-round construction process of the dictionary.

However, in response to the label data being an image, the index determination result of the label data is determined according to the image codebook, so that the index determination result is an index in the image codebook, and the index determination result is not the index (such as the at least one index) used to describe an image in the dictionary. Therefore, the index determination result cannot accurately represent the index corresponding to the label data in the dictionary. Therefore, the index determination result of the label data may be first adjusted to obtain the adjustment result, so that the at least one index includes the adjustment result, and the adjustment result is the index used to describe an image in the dictionary. Therefore, the adjustment result may more accurately represent the index corresponding to the label data in the dictionary; and then, the dictionary is updated according to the adjustment result and the index prediction result generated by the target model for the at least one piece of data, so that the updated dictionary may better describe the related information (such as an index and a discrete feature) of different types of data, so that based on the updated dictionary, the method may return to step 13 and the subsequent steps, to implement the next-round construction process of the dictionary. This may effectively overcome a problem that occurs when there is a specific offset between the index in the image codebook and the index in the dictionary and that is caused by the fact that the index obtained through conversion based on the image codebook cannot be directly applied to the dictionary, so that the dictionary may better learn how to represent each image in the image codebook in the text feature space, thereby enabling the target model based on the dictionary to better implement the unification of image understanding and image generation.

It should be noted that the present application does not limit the implementation of the step of “updating the dictionary of the target model”. For example, the step may specifically include: updating some or all of the dictionary of the target model, to ensure that the dictionary may at least learn, during the construction procedure of a plurality of iterative cycles, how to use the at least one index (such as the index 10001 to the index 15000) and the discrete feature indicated by each index of the at least one index to better represent the image described by the image codebook.

It may be learned from the foregoing related content of step 11 to step 16 that in the present application, a manner of expanding a dictionary (such as a text codebook) that is originally configured in a target model and that is used to record a correspondence between indices of different texts and discrete features of the different texts and performing a plurality of rounds of iterative cycle learning is provided to construct a dictionary that may describe different types of data in a same feature space. This may not only effectively simplify a related processing procedure of the target model based on the dictionary, but also improve the prediction performance of the target model, thereby facilitating better implementation of the unification of image understanding and image generation.

It may be learned that for the target model shown in the foregoing paragraph, as shown in FIG. 5, when the at least one piece of data includes a text 3 and an image 3, if the target model includes the mapping layer and the LLM (the LLM shown in FIG. 5) with the extended prediction head, the working principle of the target model includes: after the index determination result (the text token sequence shown in FIG. 5) of the text 3 and the index determination result (the image token sequence shown in FIG. 5) of the image 3 are obtained, first, the index determination result of the image 3 is adjusted according to the preset offset (10000 shown in FIG. 5) to obtain the adjusted index (the offset token sequence shown in FIG. 5) of the image 3; then, the discrete feature corresponding to the index determination result of the text 3 and the discrete feature corresponding to the adjusted index of the image 3 are separately searched for from the dictionary of the target model; and then, the “discrete feature corresponding to the index determination result of the text 3” and the “discrete feature corresponding to the adjusted index of the image 3” are subjected to prediction processing by the LLM to obtain the index prediction result, so that the index with the largest usage probability indicated by the index prediction result may represent the index (the current token shown in FIG. 5) obtained through the current-round prediction, so that the prediction data (the predicted answer shown in FIG. 5) for satisfying the requirement described by the text 3 and the image 3 may be generated subsequently based on the index with the largest usage probability.

It should be noted that the present application does not limit the manner of generating the prediction data shown in the foregoing paragraph. For example, the prediction data may be specifically generated as follows: after the index prediction result is obtained through the current-round prediction, the discrete feature corresponding to the “index with the largest usage probability indicated by the index prediction result” is searched for from the dictionary of the target model, so that the discrete feature may be provided to the LLM subsequently, to enable the LLM to perform the next-round prediction. This is iteratively cycled for a plurality of rounds, until when the last-round prediction is performed, the decoder is used to perform decoding processing on the index with the largest usage probability that is generated in each round of prediction, to obtain the prediction data (the predicted answer shown in FIG. 5) for satisfying the requirement described by the text 3 and the image 3.

It should be further noted that steps 11 to 16 describe the dictionary construction procedure of expanding based on the text codebook and performing a plurality of rounds of iterative updates. However, in some cases (for example, the image codebook belongs to the configuration information of the target model, but the text codebook does not belong to the configuration information of the target model), a dictionary construction procedure of expanding based on the image codebook and performing a plurality of rounds of iterative updates may be used, and the construction procedure is similar to the procedure described in steps 11 to 16. For the sake of brevity, details are not described herein again.

Research finds that to better improve the performance of the target model, some or all parameters in the target model are updated while the dictionary is updated. This is conducive to better improving the coordination between the dictionary and the target model, thereby facilitating better improvement of the prediction performance.

Based on the foregoing research, to better improve the prediction performance, the present application provides a three-stage training procedure, which may specifically include the following steps 21 to 23.

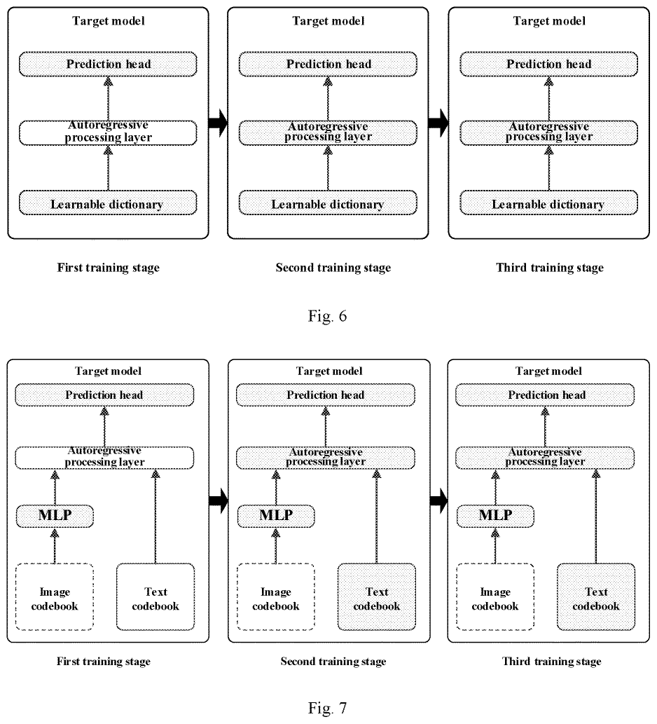

Step 21: training a dictionary of a target model and a prediction head in the target model by using first training data, to implement a first training stage (a first training stage shown in FIG. 6) of the target model, so that only the dictionary and the prediction head need to be updated in the first training stage, and through the first training stage, how to describe different types of data in a same feature space may be learned and a prediction capability of an image token may be added to the target model while an existing function (such as a capability of predicting a text token that is possessed by an LLM) of the target model is maintained.

The first training data is data used in the first training stage of the target model, for example, some or all data selected from a pre-built training database.

In addition, the present application does not limit an implementation of step 21. For example, step 21 may be implemented by using an iterative cyclic procedure similar to that shown in step 11 to step 16.

Step 22: training the dictionary of the target model and all parameters in the target model by using second training data (such as low-quality data), to implement a second training stage (a second training stage shown in FIG. 6) of the target model, so that the dictionary and all the parameters in the target model need to be updated in the second training stage, and an image understanding performance and an image generation performance of the target model may be enhanced through the second training stage.

The second training data is data used in the second training stage of the target model, for example, some or all data selected from a pre-built training database.

In addition, to better improve training efficiency, the second training data may be low-quality data selected from the pre-built training database, for example, training data including a low-resolution image, training data including a generated image with low aesthetics, or training data including a low-quality conversation. This may not only ensure that sufficient training data exists in the second training stage implemented based on the second training data, but also accelerate a model training procedure because the second training data includes the low-resolution image, to construct, as soon as possible, a target model with relatively good performance.

In addition, the present application does not limit an implementation of step 22. For example, step 22 may be implemented by using an iterative cyclic procedure similar to that shown in step 13 to step 16.

Step 23: training the dictionary of the target model and all the parameters in the target model by using third training data (such as high-quality data), to implement a third training stage (a third training stage shown in FIG. 6) of the target model, so that the dictionary and all the parameters in the target model need to be updated in the third training stage, and fine-tuning processing may be performed on the target model and the dictionary thereof through the third training stage, to achieve a better prediction effect.

The third training data is data used in the third training stage of the target model, for example, some or all data selected from a pre-built training database.

In addition, to better improve a training effect, the third training data may be high-quality data selected from the pre-built training database, for example, training data including a high-resolution image, training data including a generated image with high aesthetics, or training data including a high-quality conversation. This may ensure that the target model and the dictionary thereof that are fine-tuned by using the third training data present a better effect, thereby facilitating a better improvement of the prediction effect.

In addition, the present application does not limit an implementation of step 23. For example, step 23 may be implemented by using an iterative cyclic procedure similar to that shown in step 13 to step 16.

It may be learned from the foregoing related content of step 21 to step 23 that in the present application, a manner of three-stage training shown in FIG. 6 may be used to construct the target model and the dictionary thereof, to achieving adding new capabilities while maintaining the capabilities of an original model, so that the finally trained target model and dictionary thereof may present a better effect, thereby enabling the prediction procedure implemented based on the target model and the dictionary thereof to present a better effect, which is conducive to better implementation of the unification of image understanding and image generation.

In addition, after the three-stage training shown in the foregoing paragraph is performed, for any actual application scenario, the trained target model and dictionary thereof may be fine-tuned by using training data in the application scenario, so that the finally obtained target model and dictionary thereof may better meet a requirement (such as a requirement for cross-generation of characters and images) in the application scenario. It should be noted that the present application does not limit the application scenario. For example, the application scenario may be a recipe generation scenario, a picture-story scenario, an image editing scenario, a scenario of adjusting a speaking object presented by existing multimedia data based on a newly provided image of the speaking object (such as a real person or a virtual person), or a scenario of adjusting a style presented by existing multimedia data based on a newly provided style image.

In addition, for a target model including a mapping layer, for example, the target model shown in FIG. 4, a training procedure of the target model is similar to the three-stage training procedure shown in step 21 to step 23. For ease of understanding, description is provided below with reference to an example.

For example, when the target model includes the mapping layer (the MLP shown in FIG. 4) and the LLM (the LLM shown in FIG. 4) with the extended prediction head, and the text codebook belongs to the configuration information of the target model, the training procedure of the target model may include the following steps 31 to 33.

Step 31: training the mapping layer in the target model and the prediction head in the target model by using first training data, to implement a first training stage (a first training stage shown in FIG. 7) of the target model, so that only the mapping layer and the prediction head need to be updated in the first training stage, and through the first training stage, how to align features in different feature spaces in terms of feature dimensions (for example, aligning a discrete feature in an image feature space with an input space of the LLM, such as a text feature space) may be learned and a prediction capability of an image token may be added to the target model while an existing function (such as a capability of predicting a text token that is possessed by the LLM itself) of the target model is maintained.

It should be noted that the present application does not limit an implementation of step 31. For example, step 31 may be implemented by using an iterative cyclic procedure similar to that shown in step 13 to step 16.

Step 32: training all parameters in the target model and a text codebook of the target model by using second training data (such as low-quality data), to implement a second training stage (a second training stage shown in FIG. 7) of the target model, so that all the parameters in the target model and the text codebook need to be updated in the second training stage, and an image understanding performance and an image generation performance of the target model may be enhanced through the second training stage.

It should be noted that the present application does not limit an implementation of step 32. For example, step 32 may be implemented by using an iterative cyclic procedure similar to that shown in step 13 to step 16.

Step 33: training all the parameters in the target model and the text codebook of the target model by using third training data (such as high-quality data), to implement a third training stage (a third training stage shown in FIG. 7) of the target model, so that all the parameters in the target model and the text codebook need to be updated in the third training stage, and fine-tuning processing may be performed on the target model and the dictionary thereof through the third training stage, to achieve a better prediction effect.

It should be noted that the present application does not limit an implementation of step 33. For example, step 33 may be implemented by using an iterative cyclic procedure similar to that shown in step 13 to step 16.

It may be learned from the foregoing related content of step 31 to step 33 that in the present application, the manner of three-stage training shown in FIG. 7 may be used to update the target model and the text codebook of the target model, to achieve adding new capabilities while maintaining the capabilities of an original model, so that the finally trained target model and text codebook thereof may present a better effect, thereby enabling the prediction procedure implemented based on the target model and the text codebook thereof to present a better effect, which is conducive to better implementation of the unification of image understanding and image generation.

In addition, after the three-stage training shown in the foregoing paragraph is performed, for any actual application scenario, the trained target model and dictionary thereof may be fine-tuned by using training data in the application scenario, so that the finally obtained target model and dictionary thereof may better meet a requirement (such as a requirement for cross-generation of characters and images) in the application scenario.

It may be learned from the foregoing related content of the target model that in the present application, a decoder-only model (such as the foregoing target model) may be used to implement both image understanding and image generation, and relatively high performance may be achieved. To understand the model, description is provided below with reference to details shown in (1) to (4).
(1) For data involved in target model training, training data for image understanding, training data for image generation, and some pure text conversation data may all be uniformly processed into a conversation form, to reduce a difference between data from different sources, so that subsequently, image token conversion processing may be performed, according to an image codebook, on an image involved in the data, and text token conversion processing may be performed, according to a text codebook, on a text involved in the data; and then the data is processed, in a natural conversation form, into a unified feature (an input feature of the LLM shown in FIG. 4 or FIG. 5) and the unified feature is provided to the LLM in the target model for processing.
(2) For an input feature of the LLM in the target model, after an image token and/or a text token are obtained, one solution (the solution shown in FIG. 5) is to directly expand a capacity of an original text codebook of the LLM to add an image-related entry, so that a learnable dictionary (the learnable dictionary shown in FIG. 5) that is used to describe different types of data in a same feature space may be formed, so that subsequently, a discrete feature of the image token and a discrete feature of the text token may be directly extracted from the dictionary, and these discrete features may be directly provided to the LLM for processing. Another solution (the solution shown in FIG. 4) is to extract the discrete feature of the text token from the original text codebook, extract the discrete feature of the image token from an already-built image codebook, and map, by using a mapping layer (the MLP shown in FIG. 4), the discrete feature of the image token to a text feature space, so that output data of the mapping layer and the discrete feature of the text token are in a feature dimension alignment state, so that the output data of the mapping layer and the discrete feature of the text token may be directly provided to the LLM for processing subsequently.
(3) For the prediction head in the target model, the prediction head is obtained by extending an original prediction head in the LLM, so that a number of indices that may be predicted by the extended prediction head is a sum of a number of indices in the text codebook and a number of indices in the image codebook, thereby enabling the extended prediction head to have a function of predicting a text and an image, which is conducive to better implementation of the unification of image understanding and image generation.
(4) For the training procedure of the target model, cross entropy may be used for loss calculation.

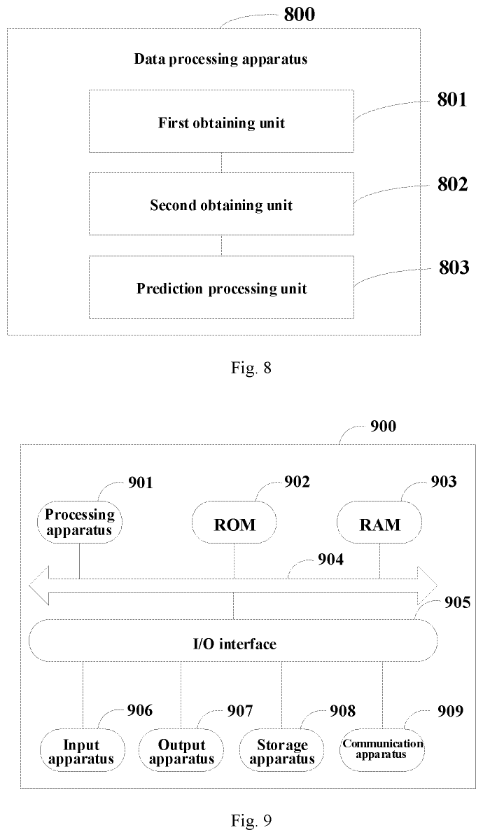

Based on the data processing method provided in the embodiments of the present application, an embodiment of the present application further provides a data processing apparatus. The data processing apparatus is described below with reference to FIG. 8. FIG. 8 is a schematic structural diagram of a data processing apparatus according to an embodiment of the present application. It should be noted that for technical details of the data processing apparatus provided in the embodiments of the present application, refer to the related content of the foregoing data processing method.

As shown in FIG. 8, the data processing apparatus 800 provided in this embodiment of the present application includes:
a first obtaining unit 801 configured to obtain at least one piece of data, where the at least one piece of data includes a text and/or an image;
a second obtaining unit 802 configured to: for any piece of data of the at least one piece of data, obtain, from a dictionary of a target model, a discrete feature matching an index determination result of the piece of data, where in response to the piece of data being a text, the index determination result is determined according to a text codebook, and in response to the piece of data being an image, the index determination result is determined according to an image codebook, where the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and
a prediction processing unit 803 configured to perform, by using the target model, prediction processing on the discrete feature matching the index determination result, to obtain an index prediction result, where the index prediction result is used to indicate a usage probability of each index in the index sequence, and a discrete feature indicated by an index with a largest usage probability that is indicated by the index prediction result in the dictionary is used to generate prediction data corresponding to the at least one piece of data.

In a possible implementation, the index sequence includes a first index set and a second index set, where an arrangement position of each index in the first index set precedes that of each index in the second index set in the index sequence; the first index set includes indices in a codebook corresponding to the first index set, the second index set is obtained by separately adding a preset offset to indices in a codebook corresponding to the second index set, and the preset offset is used to indicate a number of indices in the codebook corresponding to the first index set; and the codebook corresponding to the first index set is the text codebook, and the codebook corresponding to the second index set is the image codebook; or the codebook corresponding to the first index set is the image codebook, and the codebook corresponding to the second index set is the text codebook.

In a possible implementation, in response to the index with the largest usage probability belonging to the first index set, the discrete feature indicated by the index with the largest usage probability in the dictionary is obtained by searching the codebook corresponding to the first index set for a discrete feature indicated by the index with the largest usage probability; or in response to the index with the largest usage probability belonging to the second index set, the discrete feature indicated by the index with the largest usage probability in the dictionary is obtained by searching the codebook corresponding to the second index set for a discrete feature indicated by a difference between the index with the largest usage probability and the preset offset.

In a possible implementation, the second obtaining unit 802 is specifically configured to: for any piece of data of the at least one piece of data, in response to the piece of data being a text, search the text codebook for a discrete feature indicated by the index determination result of the piece of data, as the discrete feature matching the index determination result of the piece of data; or in response to the piece of data being an image, search the image codebook for a discrete feature indicated by the index determination result of the piece of data, as the discrete feature matching the index determination result of the piece of data.

In a possible implementation, the discrete feature indicated by each index in the text codebook belongs to a text feature space; and a mapping layer in the target model is configured to map a discrete feature searched for from the image codebook to the text feature space, and both output data of the mapping layer and the discrete feature searched for from the text codebook participate in the prediction processing.

In a possible implementation, the data processing apparatus 800 further includes:
a third obtaining unit configured to obtain at least one index and a discrete feature indicated by each index of the at least one index, where each index of the at least one index is different from each index in the text codebook, discrete features indicated by different indices of the at least one index are used to describe different images, and the discrete feature indicated by each index of the at least one index and the discrete feature indicated by each index in the text codebook belong to a same feature space;
an initialization unit configured to expand the text codebook to obtain the dictionary, by using the at least one index and the discrete feature indicated by each index of the at least one index; and
an updating unit configured to update the dictionary according to the index prediction result and an index determination result of label data corresponding to the at least one piece of data, and return to the first obtaining unit 801 to continue to perform the step of obtaining the at least one piece of data, where the label data is used to indicate a ground-truth of the prediction data, in response to the label data being a text, the index determination result of the label data is determined according to the text codebook, and in response to the label data being an image, the index determination result of the label data is determined according to the image codebook.

In a possible implementation, the third obtaining unit is specifically configured to: obtain the at least one index, and randomly generate the discrete feature indicated by each index of the at least one index.

In a possible implementation, the third obtaining unit is specifically configured to: separately add each index in the image codebook to the number of indices in the text codebook to obtain the at least one index, and separately map the discrete feature indicated by each index in the image codebook to the same feature space to obtain the discrete feature indicated by each index of the at least one index.

In a possible implementation, the second obtaining unit 802 is specifically configured to: for any piece of data of the at least one piece of data, in response to the piece of data being a text, search the dictionary for a discrete feature indicated by the index determination result of the piece of data, as the discrete feature matching the index determination result of the piece of data; or in response to the piece of data being an image, adjust the index determination result of the piece of data to obtain an adjusted index, where the at least one index includes the adjusted index, and search the dictionary for a discrete feature indicated by the adjusted index, as the discrete feature matching the index determination result of the piece of data.

In a possible implementation, the data processing apparatus 800 further includes:
an adjustment unit configured to: in response to the label data being an image, adjust the index determination result of the label data to obtain an adjustment result, where the at least one index includes the adjustment result; and
the updating unit is specifically configured to update the dictionary according to the index prediction result and the adjustment result.

In a possible implementation, the discrete feature indicated by each index in the image codebook includes a semantic-level discrete feature and a pixel-level discrete feature; and/or the target model includes one prediction head, and the index prediction result is output by the prediction head.

It may be learned from the foregoing related content of the data processing apparatus 800 that the working principle of the apparatus 800 includes: for the target model provided in the present application for unifying the two functions of image understanding and image generation, after at least one piece of data (for example, a text and/or an image that is provided by a user and that is used to describe a current requirement) is obtained, first, for any piece of data of the at least one piece of data, if the piece of data is a text, an index determination result (such as a text token) of the piece of data is determined according to the text codebook that is used to describe a correspondence between different indices and discrete features of different texts; or if the piece of data is an image, an index determination result (such as an image token) of the piece of data is determined according to the image codebook that is used to describe a correspondence between different indices and discrete features of different images. In this way, various types of data may be converted into the same type of data (such as tokens), which is conducive to eliminating an impact caused by different data types, so that the discrete feature matching the index determination result of the piece of data may be obtained from the dictionary of the target model subsequently, and the discrete feature may represent information carried by the piece of data. In this way, the process of obtaining discrete features of different types of data may be unified as much as possible by using the dictionary. Then, the prediction processing is performed by using the target model on the discrete feature obtained by using the dictionary, to obtain the index prediction result, so that the index prediction result is used to indicate the usage probability of each index in the index sequence of the dictionary, and the index with the largest usage probability indicated by the index prediction result is an index corresponding to a certain text or an index corresponding to a certain image. Therefore, the discrete feature indicated by the index with the largest usage probability in the dictionary may represent information carried by the prediction data (for example, a text or a new image that meets the requirement) generated for the at least one piece of data, so that the prediction data may be generated subsequently based on the discrete feature. In this way, the generation process of different types of data may be unified by using the dictionary.

In addition, an embodiment of the present application further provides an electronic device. The device includes a processor and a memory. The memory is configured to store an instruction or a computer program. The processor is configured to execute the instruction or the computer program in the memory, to enable the electronic device to perform any implementation of the data processing method provided in the embodiments of the present application.

FIG. 9 is a schematic structural diagram of an electronic device 900 suitable for implementing an embodiment of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable multimedia player (PMP), and a vehicle-mounted terminal (such as a vehicle navigation terminal), and fixed terminals such as a digital TV and a desktop computer. The electronic device shown in FIG. 9 is merely an example, and shall not impose any limitation on the function and scope of use of the embodiments of the present disclosure.

As shown in FIG. 9, the electronic device 900 may include a processing apparatus (such as a central processing unit and a graphics processor) 901, which may perform various appropriate actions and processing according to a program stored in a read-only memory (ROM) 902 or a program loaded from a storage apparatus 908 into a random access memory (RAM) 903. The RAM 903 further stores various programs and data required for operations of the electronic device 900. The processing apparatus 901, the ROM 902, and the RAM 903 are interconnected by using a bus 904. An input/output (I/O) interface 905 is also connected to the bus 904.

Usually, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a magnetic tape and a hard disk; and a communication apparatus 909. The communication apparatus 909 may allow the electronic device 900 to perform wireless or wired communication with another device to exchange data. Although FIG. 9 shows the electronic device 900 having various apparatuses, it should be understood that all the apparatuses shown herein are not necessarily implemented or included. More or fewer apparatuses may alternatively be implemented or provided.

In particular, according to the embodiments of the present disclosure, the procedure described above with reference to the flowchart may be implemented as a computer software program. For example, an embodiment of the present disclosure includes a computer program product including a computer program carried on a non-transitory computer-readable medium, where the computer program includes program code for performing the method shown in the flowchart. In such an embodiment, the computer program may be downloaded from a network and installed through the communication apparatus 909, or may be installed from the storage apparatus 908, or may be installed from the ROM 902. When the computer program is executed by the processing apparatus 901, the foregoing functions defined in the method of the embodiment of the present disclosure are performed.

The electronic device provided in this embodiment of the present disclosure belongs to the same inventive concept as the method provided in the foregoing embodiment. For technical details not described in detail in this embodiment, reference may be made to the foregoing embodiment, and this embodiment has the same beneficial effects as the foregoing embodiment.

An embodiment of the present application further provides a computer-readable medium having an instruction or a computer program stored thereon. When the instruction or the computer program is run on a device, the device is enabled to perform any implementation of the data processing method provided in the embodiments of the present application.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in multiple forms, and includes but is not limited to, an electromagnetic signal, an optical signal, or any suitable combination thereof. The computer-readable signal medium may alternatively be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to, a wire, an optical cable, a radio frequency (RF), or any suitable combination thereof.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The foregoing computer-readable medium may be included in the foregoing electronic device, or may exist alone without being assembled into the electronic device.

The foregoing computer-readable medium carries one or more programs, and when the one or more programs are executed by the electronic device, the electronic device may perform the foregoing method.

The computer program code for performing the operations of the present disclosure may be written in one or more programming languages or a combination thereof. The foregoing programming languages include but are not limited to object-oriented programming languages such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner, and may also be implemented in a hardware manner. The name of the unit/module does not constitute a limitation on the unit itself in some cases.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the present disclosure, a machine-readable medium may be a tangible medium that may include or store a program to be used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the embodiments in this specification are described in a progressive manner, and each embodiment focuses on differences from other embodiments. For the same and similar parts between the embodiments, reference may be made to each other. For the system or apparatus disclosed in the embodiments, because it corresponds to the method disclosed in the embodiments, the description is relatively simple, and for related parts, reference may be made to the description of the method.

It should be understood that in the present application, “at least one (item)” means one or more, and “a plurality of” means two or more. “And/or” describes an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. “At least one of the following (items/pieces)” or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should be further noted that in this specification, relational terms such as first and second are used only to distinguish one entity or operation from another entity or operation, and do not necessarily require or imply any actual relationship or order between these entities or operations. Moreover, the terms “include”, “comprise”, or any other variant thereof are intended to cover non-exclusive inclusion, so that a process, method, object, or device that includes a list of elements includes not only those elements, but also other elements not explicitly listed or elements inherent to such a process, method, object, or device. Without further restrictions, an element defined by the phrase “includes a” does not exclude the existence of another identical element in the process, method, object, or device that includes the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing descriptions of the disclosed embodiments enable those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. A data processing method, comprising:
obtaining at least one piece of data, wherein the at least one piece of data comprises at least one of a text or an image;
for any piece of data of the at least one piece of data, obtaining, from a dictionary of a target model, a discrete feature matching an index determination result of the piece of data, wherein in response to the piece of data being a text, the index determination result is determined according to a text codebook, and in response to the piece of data being an image, the index determination result is determined according to an image codebook, wherein the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and
performing, by using the target model, prediction processing on the discrete feature matching the index determination result, to obtain an index prediction result, wherein the index prediction result is used to indicate a usage probability of each index in the index sequence, and a discrete feature indicated by an index with a largest usage probability that is indicated by the index prediction result in the dictionary is used to generate prediction data corresponding to the at least one piece of data.

2. The method of claim 1, wherein the index sequence comprises a first index set and a second index set;
an arrangement position of each index in the first index set precedes that of each index in the second index set in the index sequence;
the first index set comprises indices in a codebook corresponding to the first index set, the second index set is obtained by separately adding a preset offset to indices in a codebook corresponding to the second index set, and the preset offset is used to indicate a number of indices in the codebook corresponding to the first index set; and
the codebook corresponding to the first index set is the text codebook, and the codebook corresponding to the second index set is the image codebook; or the codebook corresponding to the first index set is the image codebook, and the codebook corresponding to the second index set is the text codebook.

3. The method of claim 2, wherein in response to the index with the largest usage probability belonging to the first index set, the discrete feature indicated by the index with the largest usage probability in the dictionary is obtained by searching the codebook corresponding to the first index set for a discrete feature indicated by the index with the largest usage probability; or
in response to the index with the largest usage probability belonging to the second index set, the discrete feature indicated by the index with the largest usage probability in the dictionary is obtained by searching the codebook corresponding to the second index set for a discrete feature indicated by a difference between the index with the largest usage probability and the preset offset.

4. The method of claim 2, wherein the obtaining, from a dictionary of a target model, a discrete feature matching an index determination result of the piece of data comprises:
in response to the piece of data being a text, searching the text codebook for a discrete feature indicated by the index determination result of the piece of data, as the discrete feature matching the index determination result of the piece of data; or
in response to the piece of data being an image, searching the image codebook for a discrete feature indicated by the index determination result of the piece of data, as the discrete feature matching the index determination result of the piece of data.

5. The method of claim 4, wherein the discrete feature indicated by each index in the text codebook belongs to a text feature space; and
a mapping layer in the target model is configured to map a discrete feature searched for from the image codebook to the text feature space, and both output data of the mapping layer and the discrete feature searched for from the text codebook participate in the prediction processing.

6. The method of claim 1, further comprising:
obtaining at least one index and a discrete feature indicated by each index of the at least one index, wherein each index of the at least one index is different from each index in the text codebook, discrete features indicated by different indices of the at least one index are used to describe different images, and the discrete feature indicated by each index of the at least one index and the discrete feature indicated by each index in the text codebook belong to a same feature space;
expanding the text codebook to obtain the dictionary, by using the at least one index and the discrete feature indicated by each index of the at least one index; and
updating the dictionary according to the index prediction result and an index determination result of label data corresponding to the at least one piece of data, and then continuing to perform the step of obtaining the at least one piece of data, wherein the label data is used to indicate a ground-truth of the prediction data, in response to the label data being a text, the index determination result of the label data is determined according to the text codebook, and in response to the label data being an image, the index determination result of the label data is determined according to the image codebook.

7. The method of claim 6, wherein the obtaining at least one index and a discrete feature indicated by each index of the at least one index comprises:
obtaining the at least one index, and randomly generating the discrete feature indicated by each index of the at least one index;
or
separately adding each index in the image codebook to a number of indices in the text codebook to obtain the at least one index, and separately mapping the discrete feature indicated by each index in the image codebook to the same feature space to obtain the discrete feature indicated by each index of the at least one index.

8. The method of claim 6, wherein the obtaining, from a dictionary of a target model, a discrete feature matching an index determination result of the piece of data comprises:
in response to the piece of data being a text, searching the dictionary for a discrete feature indicated by the index determination result of the piece of data, as the discrete feature matching the index determination result of the piece of data; or
in response to the piece of data being an image, adjusting the index determination result of the piece of data to obtain an adjusted index, wherein the at least one index comprises the adjusted index, and searching the dictionary for a discrete feature indicated by the adjusted index, as the discrete feature matching the index determination result of the piece of data.

9. The method of claim 6, further comprising:
in response to the label data being an image, adjusting the index determination result of the label data to obtain an adjustment result, wherein the at least one index comprises the adjustment result; and
the updating the dictionary according to the index prediction result and an index determination result of label data corresponding to the at least one piece of data comprises:
updating the dictionary according to the index prediction result and the adjustment result.

10. The method of claim 1, wherein at least one of the following is satisfied:
the discrete feature indicated by each index in the image codebook comprises a semantic-level discrete feature and a pixel-level discrete feature;
or
the target model comprises one prediction head, and the index prediction result is output by the prediction head.

11. An electronic device, comprising a processor and a memory, wherein
the memory is configured to store an instruction or a computer program; and
the processor is configured to execute the instruction or the computer program in the memory, to enable the electronic device to perform a data processing method, comprising:
obtaining at least one piece of data, wherein the at least one piece of data comprises at least one of a text or an image;
for any piece of data of the at least one piece of data, obtaining, from a dictionary of a target model, a discrete feature matching an index determination result of the piece of data, wherein in response to the piece of data being a text, the index determination result is determined according to a text codebook, and in response to the piece of data being an image, the index determination result is determined according to an image codebook, wherein the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and
performing, by using the target model, prediction processing on the discrete feature matching the index determination result, to obtain an index prediction result, wherein the index prediction result is used to indicate a usage probability of each index in the index sequence, and a discrete feature indicated by an index with a largest usage probability that is indicated by the index prediction result in the dictionary is used to generate prediction data corresponding to the at least one piece of data.

12. The electronic device of claim 11, wherein the index sequence comprises a first index set and a second index set;
an arrangement position of each index in the first index set precedes that of each index in the second index set in the index sequence;
the first index set comprises indices in a codebook corresponding to the first index set, the second index set is obtained by separately adding a preset offset to indices in a codebook corresponding to the second index set, and the preset offset is used to indicate a number of indices in the codebook corresponding to the first index set; and
the codebook corresponding to the first index set is the text codebook, and the codebook corresponding to the second index set is the image codebook; or the codebook corresponding to the first index set is the image codebook, and the codebook corresponding to the second index set is the text codebook.

13. The electronic device of claim 12, wherein in response to the index with the largest usage probability belonging to the first index set, the discrete feature indicated by the index with the largest usage probability in the dictionary is obtained by searching the codebook corresponding to the first index set for a discrete feature indicated by the index with the largest usage probability; or
in response to the index with the largest usage probability belonging to the second index set, the discrete feature indicated by the index with the largest usage probability in the dictionary is obtained by searching the codebook corresponding to the second index set for a discrete feature indicated by a difference between the index with the largest usage probability and the preset offset.

14. The electronic device of claim 12, wherein the obtaining, from a dictionary of a target model, a discrete feature matching an index determination result of the piece of data comprises:
in response to the piece of data being a text, searching the text codebook for a discrete feature indicated by the index determination result of the piece of data, as the discrete feature matching the index determination result of the piece of data; or
in response to the piece of data being an image, searching the image codebook for a discrete feature indicated by the index determination result of the piece of data, as the discrete feature matching the index determination result of the piece of data.

15. The electronic device of claim 14, wherein the discrete feature indicated by each index in the text codebook belongs to a text feature space; and
a mapping layer in the target model is configured to map a discrete feature searched for from the image codebook to the text feature space, and both output data of the mapping layer and the discrete feature searched for from the text codebook participate in the prediction processing.

16. The electronic device of claim 15, wherein the data processing method further comprises:
obtaining at least one index and a discrete feature indicated by each index of the at least one index, wherein each index of the at least one index is different from each index in the text codebook, discrete features indicated by different indices of the at least one index are used to describe different images, and the discrete feature indicated by each index of the at least one index and the discrete feature indicated by each index in the text codebook belong to a same feature space;
expanding the text codebook to obtain the dictionary, by using the at least one index and the discrete feature indicated by each index of the at least one index; and
updating the dictionary according to the index prediction result and an index determination result of label data corresponding to the at least one piece of data, and then continuing to perform the step of obtaining the at least one piece of data, wherein the label data is used to indicate a ground-truth of the prediction data, in response to the label data being a text, the index determination result of the label data is determined according to the text codebook, and in response to the label data being an image, the index determination result of the label data is determined according to the image codebook.

17. The electronic device of claim 16, wherein the obtaining at least one index and a discrete feature indicated by each index of the at least one index comprises:
obtaining the at least one index, and randomly generating the discrete feature indicated by each index of the at least one index;
or
separately adding each index in the image codebook to a number of indices in the text codebook to obtain the at least one index, and separately mapping the discrete feature indicated by each index in the image codebook to the same feature space to obtain the discrete feature indicated by each index of the at least one index.

18. The electronic device of claim 16, wherein the obtaining, from a dictionary of a target model, a discrete feature matching an index determination result of the piece of data comprises:
in response to the piece of data being a text, searching the dictionary for a discrete feature indicated by the index determination result of the piece of data, as the discrete feature matching the index determination result of the piece of data; or
in response to the piece of data being an image, adjusting the index determination result of the piece of data to obtain an adjusted index, wherein the at least one index comprises the adjusted index, and searching the dictionary for a discrete feature indicated by the adjusted index, as the discrete feature matching the index determination result of the piece of data.

19. The electronic device of claim 16, wherein the data processing method further comprises:
in response to the label data being an image, adjusting the index determination result of the label data to obtain an adjustment result, wherein the at least one index comprises the adjustment result; and
the updating the dictionary according to the index prediction result and an index determination result of label data corresponding to the at least one piece of data comprises:
updating the dictionary according to the index prediction result and the adjustment result.

20. A non-transitory computer-readable medium having an instruction or a computer program stored thereon, wherein when the instruction or the computer program is run on a device, the device is enabled to perform a data processing method, comprising:
obtaining at least one piece of data, wherein the at least one piece of data comprises at least one of a text or an image;
for any piece of data of the at least one piece of data, obtaining, from a dictionary of a target model, a discrete feature matching an index determination result of the piece of data, wherein in response to the piece of data being a text, the index determination result is determined according to a text codebook, and in response to the piece of data being an image, the index determination result is determined according to an image codebook, wherein the dictionary is constructed according to the text codebook and the image codebook, a length of an index sequence of the dictionary is a sum of a number of indices in the text codebook and a number of indices in the image codebook, discrete features indicated by different indices in the text codebook are used to describe different texts, and discrete features indicated by different indices in the image codebook are used to describe different images; and
performing, by using the target model, prediction processing on the discrete feature matching the index determination result, to obtain an index prediction result, wherein the index prediction result is used to indicate a usage probability of each index in the index sequence, and a discrete feature indicated by an index with a largest usage probability that is indicated by the index prediction result in the dictionary is used to generate prediction data corresponding to the at least one piece of data.
